(19) United States
(12) Patent Application Publication
(10) Pub. No.: US 2010/0010786 A1
(43) Pub. Date: Jan. 14, 2010

(54) SOUND SYNTHESIS METHOD AND SOFTWARE SYSTEM FOR SHAPE-CHANGING GEOMETRIC MODELS

(76) Inventor: CYNTHIA MAXWELL, Menlo Park, CA (US)

Correspondence Address: MCKEE, VOORHEES & SEASE, P.L.C., 801 GRAND AVENUE, SUITE 3200, DES MOINES, IA, 50309-2721, US

(21) Appl. No.: 12/169,281

(22) Filed: Jul. 8, 2008

(51) Int. Cl. G06F 7/60; G06F 17/10

(52) U.S. Cl. 703/2

(57) ABSTRACT

New methods and software tools that simulate interacting with geometric shapes to synthesize sound are provided. The invention includes methods for determining real-time resonant frequencies for shape-changing geometric objects and interactive software articles/systems that allow users to simulate in real time resonant frequencies of an object as changes are made to its geometry and other sound input parameters.

### BACKGROUND OF THE INVENTION

The present invention relates to sound synthesis. More particularly, but not exclusively, the present invention relates to new methods and software tools that simulate interacting with geometric shapes to synthesize sound. The present invention has wide-ranging applications, such as the design of musical instruments, loudspeaker casings, architectural spaces and the like.

With fast computers and modern techniques, one can synthesize various sounds in real time. When objects, such as musical instruments, are used to generate sound, it would be desirable to know how changing the shape of the object, or the materials that make up the object, will change the object's sound. When such changes are made to the object, interactive sounds synthesis in real time is problematic. The primary reason is because the computational techniques used in modal synthesis for sound generation are time-consuming.

The modal synthesis method lends itself naturally to sound synthesis, because it allows one to accurately model object sounds without the need to explicitly program the properties of several oscillators. Instead, oscillator properties are determined by the system equations, which depend on the object's geometry and mathematical properties.

Using a modal decomposition, one can convert a large system of coupled linear differential equations into simple, independent differential equations in one variable, which is much more efficient than solving the original coupled system. The modal response of an object is determined by performing a system eigendecomposition to arrive at eigenvectors forming a basis for the object's motion and eigenvalues determining the resonant frequencies of the object. The eigenvalues and eigenvectors provide the information needed to recreate the object's surface as it deforms.

This eigenvalue problem is relatively expensive to perform. And, to design new object shapes with standard modal analysis, one would need to recompute the modes for each new design—a prohibitively expensive step for an interactive software computational and musical tool. Put another way, a significant limitation of using the modal method for designing sound generating objects, such as instruments, is the cost of computing the eigen-information. This affects the modifications that can be made to the object's geometry and material after the eigensolution has been determined. To design an object from physical simulation, it would be desirable to be able to compute modes in real time, so that the geometry, and therefore spectrum, of the object can be changed interactively.

For example, plate reverberation has traditionally been used as a synthetic means to simulate large room acoustics. It was one of the first types of artificial reverberation used in recording. Despite the unnatural sound produced as compared to large room reverberation, plates were used extensively due to their relative low cost and size. More recently, researchers have looked for a means of digitally simulating plate reverberation to recreate this unique analogue recording style.

Analogue plate reverberation works by mounting a steel plate with tension supplied by springs at the corners where the plate is attached to a stable frame. A signal from a transducer is applied to the plate, causing it to vibrate. This vibration is then sensed elsewhere on the plate with contact microphones. A nearby absorbing pad can also be used to control the near-field radiation.

By using a physical model, one can modify the geometry of the plate and input/output parameters. To simulate plate vibration, the model can be discretized in space and time using finite differences. One significant drawback of this method, however, is the large performance requirements, preventing the model from running in real time on an average digital workstation. A need therefore exists for methods of computing reverberation in real-time that still allows for modifications of the plate and input/output parameters.

### BRIEF SUMMARY OF THE INVENTION

It is a primary object, feature, or advantage of the present invention to improve over the state-of-the-art.

It is a further object, feature, or advantage of the present invention to provide improved computational tools to aid in the design of a musical instrument and other sound generating objects.

It is a still further object, feature, or advantage of the present invention to provide computer-implemented methods of simulating in real-time the resonant frequencies of an object of arbitrary geometry as changes are made to the geometry of the object.

Yet another object, feature, or advantage of the present invention is the provision of a software article/system for interactive use by a user in simulating reverberation in real time for a structure represented by a finite element model.

A still further feature, object, or advantage of the present invention is the provision of a software system/article that allows users to interact with an object either in a plate reverberation or instrument design mode to understand how changing the shape and/or materials of the object will change the resulting sound.

One or more of these and/or other objects, features, or advantages of the present invention will become apparent from the specification and claims that follow.

According to one aspect of the present invention, the computer-implemented method of simulating in real time the resonant frequencies of an object as changes are made to the geometry of the object is provided. Using modal synthesis methods, a modal decomposition of a finite element model of the object is computed. Changes are made to the geometry of the object and the corresponding finite element model, and estimated resonant frequencies for the object as modified are computed. A simulated sound for the object as modified is rendered by applying an impulse to the object. The Rayleigh-Ritz method is preferably used to compute the estimated resonant frequencies for the object as modified. A three-dimensional representation of the object can also be rendered on a computer display, and various locations on the object can be mapped to controllers on a digital interface to allow the user to select a location on the object to apply the impulse.

According to another aspect of the invention, a computer-implemented method of designing an instrument in real time is provided. The method includes providing a finite element model for the instrument and computing a modal decomposition for the finite element model. A three-dimensional graphical representation of the instrument is displayed on a computer display. Once changes are made to the geometry of the instrument and the corresponding finite element model, a three-dimensional graphical representation of the instrument as modified is rendered on the computer display and estimated resonant frequencies for the instrument as modified are computed. A simulated sound for the instrument as modified is then rendered by applying an impulse to the instrument. The estimated resonant frequencies are again preferably performed using the Rayleigh-Ritz method.

Another aspect of the present invention is a software article for interactive use in simulating reverberation in real time for a structure represented by a finite element model. Upon receiving an input from the user to modify the geometry of the structure, modifications to the finite element model are made and estimated resonant frequencies for the structure as modified are computed. In an interactive fashion, the software enables the user to render a simulated sound by applying an impulse at one of various locations on the structure as modified. The impulse can include complex waveforms.

According to another aspect of the invention, a software article for interactive use in generating sounds in real time for a virtual instrument is provided. Estimated resonant frequencies are computed in real time as the user modifies the geometric parameters of the object and/or other sound-shaping input parameters. Musical notes can be mapped to controllers on a digital interface to enable a user to play the virtual instrument using a peripheral device, such as a MIDI/OSC keyboard.

### BRIEF DESCRIPTION OF THE DRAWINGS

FIG. 1 is a diagram, showing a planar geometry before and after deformation.

FIG. 2 is a two-dimensional simple plate model.

FIG. 3 is a chart illustrating the approximation error for different changes in height of the plate model shown in FIG. 2 using only one sample point.

FIG. 4 is a chart similar to FIG. 3 but using two sample points.

FIG. 5 is a chart, comparing predicted and actual resonant frequencies for the plate model shown in FIG. 2.

FIG. 6 is a chart illustrating percent error from actual versus change in height. This chart shows that using two sample points converges faster.

FIG. 7 is a chart showing percent error from actual versus mode number using a larger basis.

FIG. 8 is a chart similar to FIG. 7 but uses geometric remapping.

FIG. 9 is a chart similar to FIG. 7 but uses geometric remeshing.

FIG. 10 is a two-dimensional illustration of a curved plate model.

FIG. 11 is a chart illustrating percent error from actual versus mode number for the curved plate model in FIG. 10 using one sample point.

FIG. 12 is a chart similar to FIG. 11 using two sample points.

FIG. 13 is a chart, showing a comparison of predicted and actual resonant frequencies for the curved plate model in FIG. 10.

FIG. 14 is a chart showing percent error from actual versus mode number using geometric remapping.

FIG. 15 is a chart similar to FIG. 14 using geometric remeshing.

FIG. 16 is a perspective view of a tetrahedral solid model.

FIG. 17 is a chart illustrating percent error from actual versus mode number.

FIG. 18 is a chart, comparing predicted and actual resonant frequencies for the solid model in FIG. 16.

FIG. 19 is a chart, showing percent error from actual versus mode number using geometric remapping.

FIG. 20 is a chart similar to FIG. 19 using geometric remeshing.

FIG. 21A is a perspective view of a shell model.

FIG. 21B is a diagram illustrating control points used for the shell model in FIG. 21A.

FIG. 22 is a chart, showing percent error from actual versus mode number with changes in height made to the shell model in FIG. 21A using one sample point.

FIG. 23 is a chart similar to FIG. 22 using two sample points.

FIG. 24 is a chart, showing error versus step size and is similar to FIG. 6.

FIG. 25 is a chart, illustrating the comparison of predicted and actual resonant frequencies for the shell model in FIG. 21A.

FIG. 26 is a chart, illustrating the time to compute in a new frequency spectrum for the shell model in FIG. 21A. This chart demonstrates the improved computational performance of the proposed system.

FIG. 27 is a block diagram of an exemplary sound synthesis software system for use in instrument design.

FIG. 28 is a pictorial representation of the user interface for the virtual instrument sound synthesis software system shown in FIG. 27.

FIG. 29 is a pictorial representation of the user interface for a shape changing synthesizer.

FIG. 30 is a pictorial representation of the user interface for a shape changing plug-in, showing four different models made from modifying control points.

FIG. 31 is comprises charts, showing the frequency spectrum for the four deformed shapes in FIG. 30.

FIG. 32 is a block diagram of the sound synthesis engine for use in a reverberation mode.

FIG. 33 is a pictorial representation of a user interface for the audio effect system in FIG. 32.

FIG. 34 is a pictorial representation of a user interface similar to FIG. 33.

FIG. 35 comprises charts of amplitude versus time for forces applied to the object (top), response of the object shown in FIG. 33 (middle) and response of the object shown in FIG. 34.

FIG. 36 comprises charts of frequency versus time for forces applied to the object (top), response of the object shown in FIG. 33 (middle) and response of the object shown in FIG. 34.

### DETAILED DESCRIPTION OF EXEMPLARY EMBODIMENTS

The present invention provides new methods and computational tools that provide for real-time reverberation simulation and interactive sound synthesis for objects as the objects undergo shape change. Given a finite element analysis of a geometric object, the vibration of the object can be computed efficiently using modal synthesis. As explained previously, to use modal synthesis, one must first compute a partial eigenvalue decomposition of the system matrices. This eigenvalue problem is relatively time-consuming, but only needs to be computed once for a given object. To evaluate changes to the resonant frequencies of the object after undergoing a shape change, one would normally need to recomputed the modes for each new design or shape, which is a time-consuming step for an interactive software tool.

The following description of exemplary embodiments describes methods for estimating the resonant frequencies for shape-changing geometric objects. Once the modal decomposition is performed and the model is broken up into uncoupled resonators, one can interact with the model quite efficiently and in real time to generate realistic sounds. A detailed description of preferred software systems is provided that enables users to interact with the model as an instrument. As an instrument, the user can feel as though she is “playing” the object by applying forces to a physical interface. Alternatively, a user can select an audio input to be played at various locations on the object in order to simulate plate reveration.

Those skilled in the art having the benefit of this disclosure will appreciate that the present invention extends far beyond simple instrument design and plate reverberation, and has direct application into such fields as sonic aesthetic design of architectural performance spaces, mechanical engineering design, and musical sculptures. By way of example only, the present invention can be used not only in designing new instruments, but in designing loudspeaker casings, architectural spaces, and can be used to actively dampen and selectively cancel resonant frequencies of an object or instrument to thereby change the sound characteristics of the object or instrument.

### Methods for Determining Real-Time Resonant Frequencies for Shape-Changing Geometric Objects

Once an object has undergone a shape change and changes have been made to the corresponding geometric finite element model of the object, the present invention provides a method that obviates recomputing modes for the object while still providing an accurate representation of the timbre of the object. The method exploits properties of parameter-dependent linear systems by tracking an invariant subspace as modifications are made. Using the method, one can forego the need for recomputing the spectrum. Results show high accuracy from moderate shape changes. The method can also be implemented using a conventional computer processor in a modest linear time for standard finite element discretizations.

Model Reduction

The eigenvalue problem that we want to solve is:

Ax=λBx (1)

where A and B are the positive definite symmetric stiffness and mass matrices respectively (i.e. K and M), and x is the vector of nodal displacements of the mode with natural frequency λ=ω². One means of formulating approximate equations for freely vibrating discrete systems is via the Rayleigh's quotient:

$${λ}_{R} = \frac{{\hat{x}}^{T} A \hat{x}}{{\hat{x}}^{T} B \hat{x}} \qquad ( 2 )$$

where \hat{x} is an approximation to x. The relative accuracy of methods based upon this formulation results from the fact that eigenvalues λ are stationary with respect to perturbations in the elements of A, B, and the eigenvectors x. Thus, if a transformation for the n physical node displacements, \hat{x}, into fewer (m<n) generalized coordinates is available, say

$$\begin{matrix}\hat{x} \\ n \times 1\end{matrix} = \begin{matrix}V \\ n \times m\end{matrix} \begin{matrix}y \\ m \times 1\end{matrix} \qquad ( 3 )$$

then the corresponding Rayleigh quotient becomes

$${λ}_{R} = \frac{{y}^{T} {V}^{T} AVy}{{y}^{T} {V}^{T} BVy} . \qquad ( 4 )$$

Making λ_{R} stationary to arbitrary variations in the m elements of y yields the reduced eigenproblem

V^{T}AVy=λ_{R}V^{T}BVy (5)

We can view this reduction as imposing n−m constraints on the original system thus giving the following result using the Cauchy Interlace Theorem.

λ⁽ⁱ⁾≦λ_{R}⁽ⁱ⁾≦λ^{(j+n-m)}j≦m. (6)

Thus all the λ_{R} are contained between λ⁽ⁱ⁾ and λ⁽ⁿ⁾ and the approximations become exact for m=n.

The essence of the reduction scheme lies in the definition of the transformation matrix V. It is preferable to use a matrix that is made from exact modal vectors. By using the exact model vectors, one can use trial functions that are similar to the actual eigenvectors under small perturbations.

In the Rayleigh-Ritz method, the shape of deformation of the continuous system v(x) is approximated using a trial family of admissible functions that satisfy the geometric boundary condition of the problem

$$v ( x ) = {\sum }_{i = 1}^{n} {c}_{i} {φ}_{i} ( x ) \qquad ( 7 )$$

where cᵢ are unknown constant coefficients and φᵢ are the known (or selected) trial family of admissible functions.

The accuracy of the method depends on the value of the number n and the choice of trial functions φᵢ(x) used in the approximation. By using a larger n, the approximation can be made more accurate, and by using trial functions which are close to the true eigenfunctions, the approximation can be improved. That is, using a larger subset of functions can provide a better interpolation to the true solution. Similarly, using interpolation functions which closely fit the true solution yields a better estimate. By using eigenvectors found from previous modifications to the same shape, one can utilize the best estimate to the current modification by using information from a previous modification.

If we use this approximation technique to estimate the vectors forming the solution to the eigenvalue problem in Equation (5), we have

$$y = {\sum }_{a = 1}^{n} {q}_{a} {U}_{n} \qquad ( 8 )$$

or y=Uq where U=[U₁U₂, . . . , Uₙ]. Substituting into Equation (5) we have

U^{T}KUq=λᵣU^{T}MUq. (9)

In this form, one can see why using a subspace formed of eigenvectors of similar systems will generate an accurate approximation for the solution to the original system. We use this form to approximate the solution as the geometry changes.

Approximation From a Subspace

Let s denote a geometric parameter. For a given finite element model, we have generalized eigenvalue problem

(K(s)−λ(s)*M(s))u(s)=0, (10)

where K(s) is the stiffness matrix of the system and M(s) is the mass matrix at the given state of the geometry, and λ(s) and u(s) are an eigenvalue and its corresponding eigenvector for the system.

If w(s) is accurate to O(h) as an estimate for u(s), then

μ(s)=(w(s)*K(s)w(s))/(w(s)*M(s)w(s)) (11)

is accurate to O(h²) as an estimate for λ(s).

Suppose that we have computed eigenpairs (λ(sₒ), u(sₒ)) and λ(s₁),u(s₁)), and now want to compute the pair (λ(s₂),u(s₂)). Then we can use the initial approximation μ(s) drawn from a Rayleigh-Ritz approximation on the pencil

(U*Ks₂)U,U*M(s₂)U) (12)

where U=[u(sₒ),u(s₁)] (or if several of the lowest eigenvalues are desired, then simply replace u(sₒ) with u1(sₒ),u2(sₒ), . . . and u(s₁) with u1(s₁),u2(s₁), etc.). For most systems, only the first few natural frequencies and associated natural modes greatly influence the dynamic response, and the contribution of higher natural frequencies and the corresponding mode shapes in negligible.

If the step size is O(h), then the error in approximating ui(s₂) by extrapolating through uᵢ(sₒ) and ui(s1) should be O(h²)—the approximation is good through the linear term—and the eigenvalue approximation should be O(h⁴). More generally, if one uses invariant subspaces computed at k points, one should get O(h^{k}) accuracy in the eigenvector, and a corresponding O(h^{2k}) accuracy in the computed eigenvalue.

Therefore, by building a basis from n eigenvectors sampled at k locations in parameter space, we can predict the same n eigenvectors and the corresponding eigenvalues at nearby points. In essence, by looking at a couple of steps, we can capture the behavior of the eigenvectors as the geometry changes and by solving a smaller eigenproblem, we can reduce the time to compute the decomposition in order to determine a subset of eigenvalues and eigenvectors.

Variable Mapping

Given that changes made to the geometry are parametric in nature, it is possible to map the geometries from step to step, and interpolate the variables of interest to the current configuration.

In this example, we will use a triangular plate element to discretize the domain. First we examine mapping the scalar fields from one mesh to another. We then describe how to map the vector fields from one mesh to another.

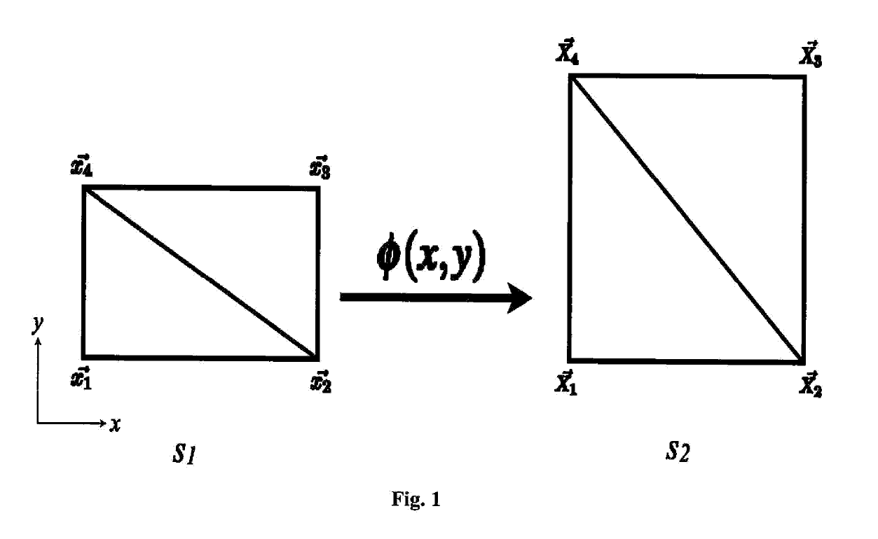

FIG. 1 shows a planar geometry at two sample points s₁ and s₂, where \vec{x}ᵢ represents the coordinates of the geometry at a point.

The map between these geometries can be defined with the following the parametric relation:

$$φ ( x , y ) = ( x , y \frac{{}^{s} 2}{{}^{s} 1} ) \qquad ( 13 )$$

where s₁ and s₂ represent the height parameter values at the two sample points.

To map the undeformed geometry (FIG. 1) (left)) to the deformed geometry (FIG. 1 (right)), we apply the map:

\vec{X}=φ\vec{x} (14)

to each node in the undeformed geometry.

This mapping brings the domain covered by the first shape to be the same as the domain covered by the second shape. It can be used for example, to overlay the original geometry onto the deformed geometry for mapping after the re-meshing process.

Next we examine mapping the vector rotation field for a triangular plate element.

Vector Field

Returning to the scalar map φ, differentiating this expression we arrive at the Tangent Map:

$$D ( φ ) = [ \begin{matrix}1 & 0 \\ 0 & \frac{s 2}{s 1}\end{matrix} ] \qquad ( 15 )$$

We use this map to transfer the vector fields from one mesh to another. That is, for each node, we apply the tangent map:

\vec{X}=D(φ)\vec{x} (16)

Putting these changes together we arrive at the map for scalar and vector fields:

$${T}_{i} = [ \begin{matrix}1 & 0 \\ 0 & D ( phi )\end{matrix} ] \qquad ( 17 )$$

For large changes, the parametric deformation applied to mesh might distort the finite elements. In these cases, one would need to re-mesh the domain. Therefore an additional map must be applied to map the variables in the old geometry, to variables in the new geometry, essentially transferring variables from one mesh to another. This operation is similar to the variable mapping, but the number of nodes in the new mesh is not necessarily the same as the number of nodes in the old mesh.

Remeshing

To transfer variables in the old geometry to the variables in the new geometry, we interpolate the value using the finite element interpolation functions. For each node in the new geometry, we find a surrounding element from the old geometry. This can be performed using an inside/outside search. Once we select an element, we find the local coordinates ξ and η using the element shape functions.

For example, for a linear triangular element, we know that for any point

$$\begin{matrix}\vec{x} ( ξ , η ) = {\sum }_{i = 1}^{3} {N}_{i} ( ξ , η ) {\vec{x}}_{i} & ( 18 ) \\ where & \\ {N}_{1} ( ξ , η ) = 1 - ξ - η & ( 19 ) \\ {N}_{2} ( ξ , η ) = ξ & ( 20 ) \\ {N}_{3} ( ξ , η ) = η & ( 21 )\end{matrix}$$

We then solve the system

ξ(x₂−x₁)+η(x₃−x₁)+(x₁−xᵢ)=0 (22)

ξ(y₂−y₁)+η(y₃−y₁)+(y₁−yᵢ)=0 (23)

for ξ andη.

For mapping from old mesh to new mesh, we then have

$$\{ \begin{matrix}{x}_{1}^{′} \\ {x}_{2}^{′} \\ {x}_{3}^{′} \\ {x}_{4}^{′} \\ {x}_{5}^{′}\end{matrix} \} = [ \begin{matrix}{M}_{1} ( {X}^{1} ) & {M}_{2} ( {X}^{1} ) & {M}_{2} ( {X}^{1} ) & {M}_{3} ( {X}^{1} ) \\ {M}_{1} ( {X}^{2} ) & {M}_{2} ( {X}^{2} ) & {M}_{2} ( {X}^{2} ) & {M}_{3} ( {X}^{2} ) \\ {M}_{1} ( {X}^{3} ) & {M}_{2} ( {X}^{3} ) & {M}_{2} ( {X}^{3} ) & {M}_{3} ( {X}^{3} ) \\ {M}_{1} ( {X}^{4} ) & {M}_{2} ( {X}^{4} ) & {M}_{2} ( {X}^{4} ) & {M}_{3} ( {X}^{4} ) \\ {M}_{1} ( {X}^{5} ) & {M}_{2} ( {X}^{5} ) & {M}_{2} ( {X}^{5} ) & {M}_{3} ( {X}^{5} )\end{matrix} ] \{ \begin{matrix}{x}_{1} \\ {x}_{2} \\ {x}_{3} \\ {x}_{4}\end{matrix} \} \qquad ( 24 )$$

where Mⱼ(Xⁱ) is the shape function of the old element evaluated at the point in the new mesh.

We can rewrite Equation 24 as

x′=hx (25)

Recall that we are using this mapping to transfer the eigenvector information from one geometry to the next under deformation. Therefore, for each eigenvector of interest, we use the mapping matrix, H, to interpolate to the new system size.

v′=Hv (26)

where H=h×I expands the mapping to the number of degrees of freedom at each node.

We can apply this technique to the eigenvectors of the old system to transfer them to the new system. We then use the vectors as before, concatenating them to form a Ritz Basis.

The preferred method used to approximate the resonant frequencies following shape change has been shown to be accurate while reducing the computational time to enable real-time analysis. Various geometries can be formed using a parametric method have been tested for examination of the method. For each geometric object, first we examine using the eigenvectors from the previous iterations directly, i.e. no geometric remapping. We then examine using geometric remapping to “warp” the eigenvectors from the old geometry to the new geometry. Finally, we examine using geometric remeshing to transfer eigeninformation from one mesh to another.

### EXAMPLE 1

### Square

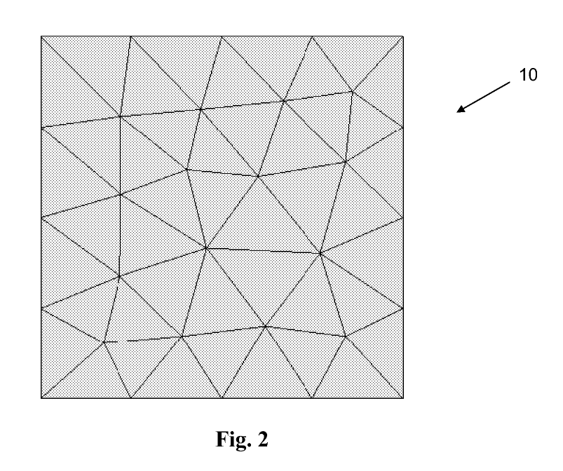

We examined changing the height of a 1 mm tall×1 m wide plate by 10 cm, 1 cm, and 1 mm and examined the error in the prediction of the new resonant frequencies of the system. The geometric object 10 shown in FIG. 2 uses 44 triangular plate elements where each node has three degrees-of-freedom

$$( w , \frac{d w}{d x} , \frac{d w}{d y} )$$

per node.

No Geometric Mapping

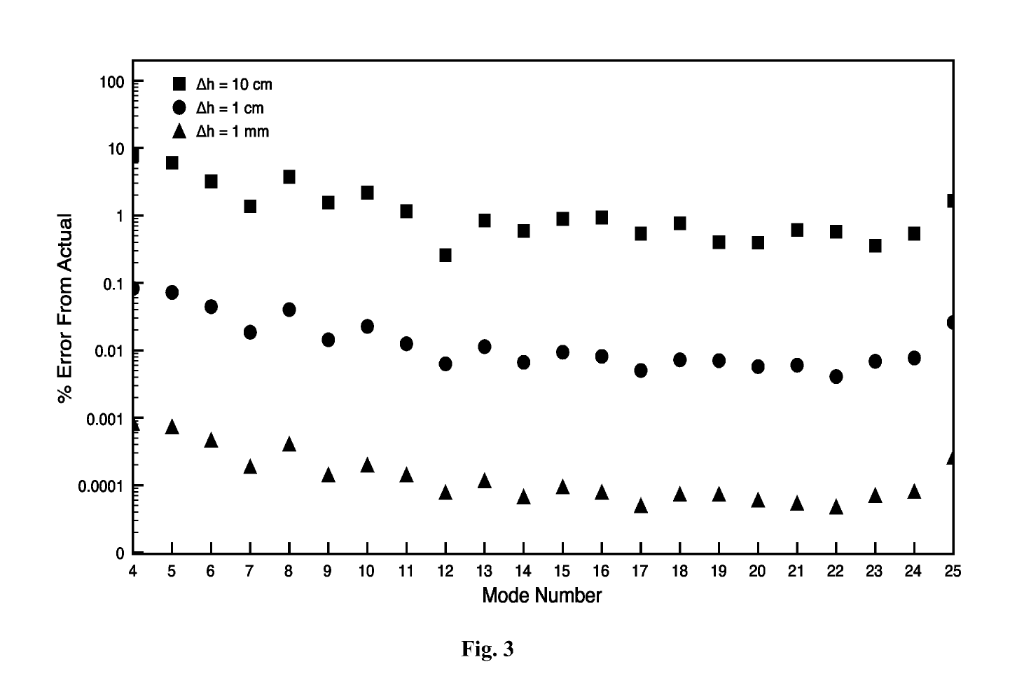

When simply concatenating the previous eigenvectors, the approximation to the actual eigenvalues are shown in FIG. 3 for various changes in square height. Using only one sample point in parameter space, s, the accuracy in prediction of the eigenvalues can be evaluated. The results show prediction errors of 7.5×10⁻⁵% for the smallest step size and 87.5% for the largest step size. Smaller changes in geometry allowed for better prediction of the new eigensolution. In each of the plots, we consider the first 25 non-zero eigenvalues.

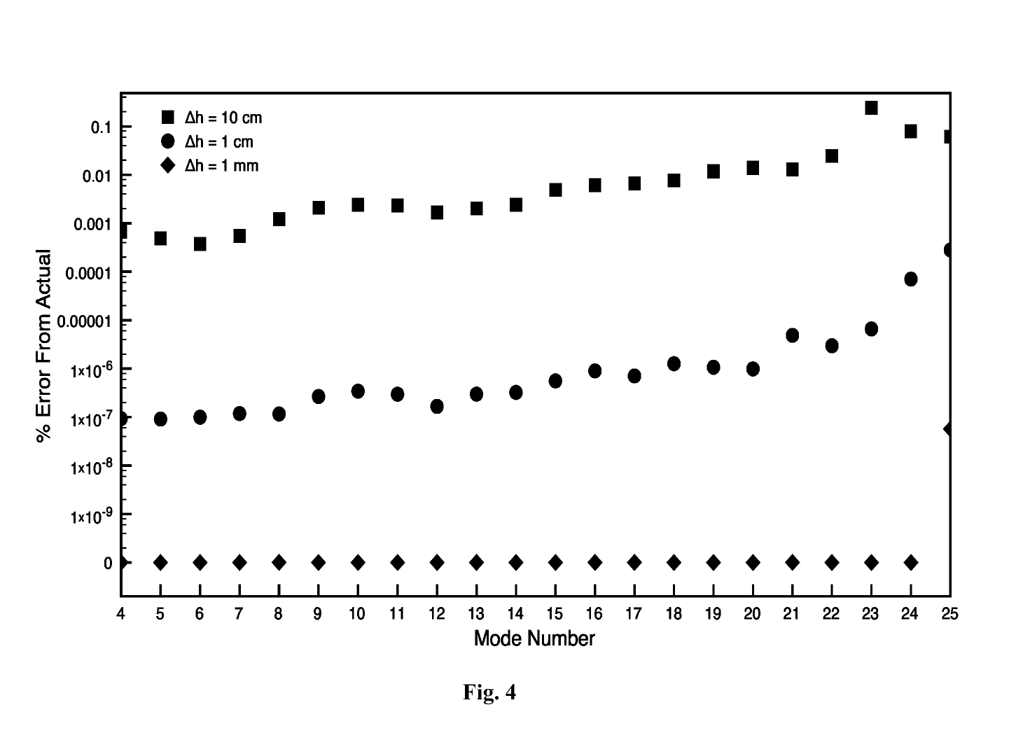

Next, we examine using two sample points. FIG. 4 shows the results for the different step sizes. The results show prediction errors of 0% for the smallest step size and 0.24% for the largest step size. Using more points in parameter space increased the accuracy of the predictions. The accuracy of the two-subspace version is almost twice as many digits as the one-subspace version which agrees with the theoretical bounds discussed previously.

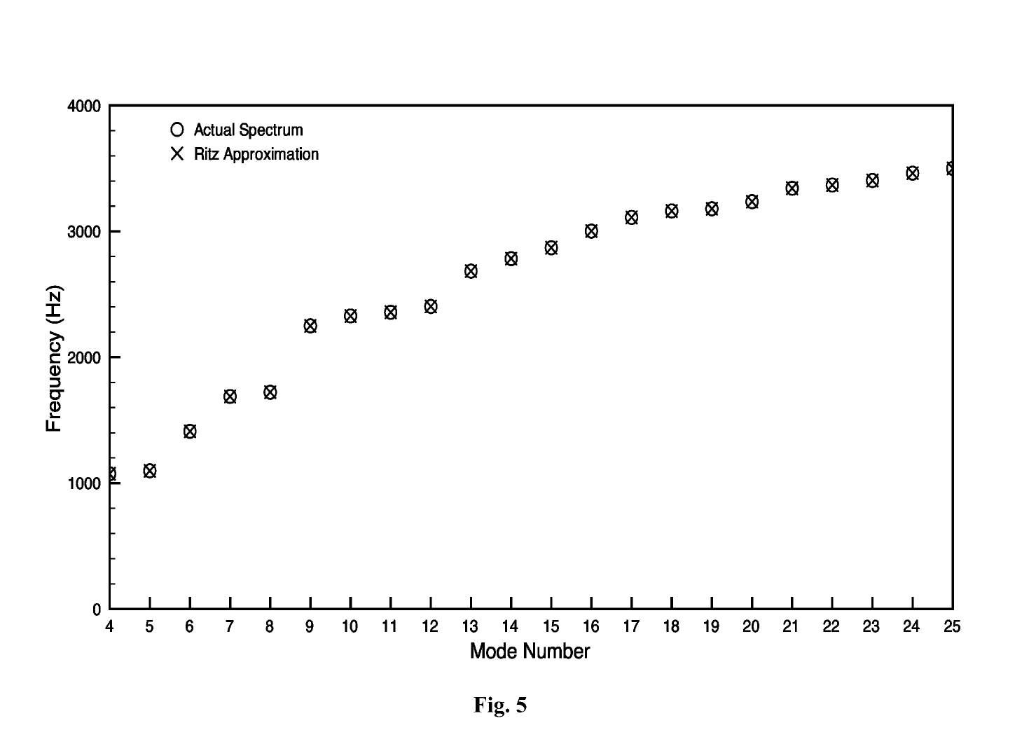

FIG. 5 shows a comparison between the predicted and the actual resonant frequencies for an overall 20 cm change (two sample points each making a 10 cm change) in height. These results show that the approximations are so close that the two lines overlap.

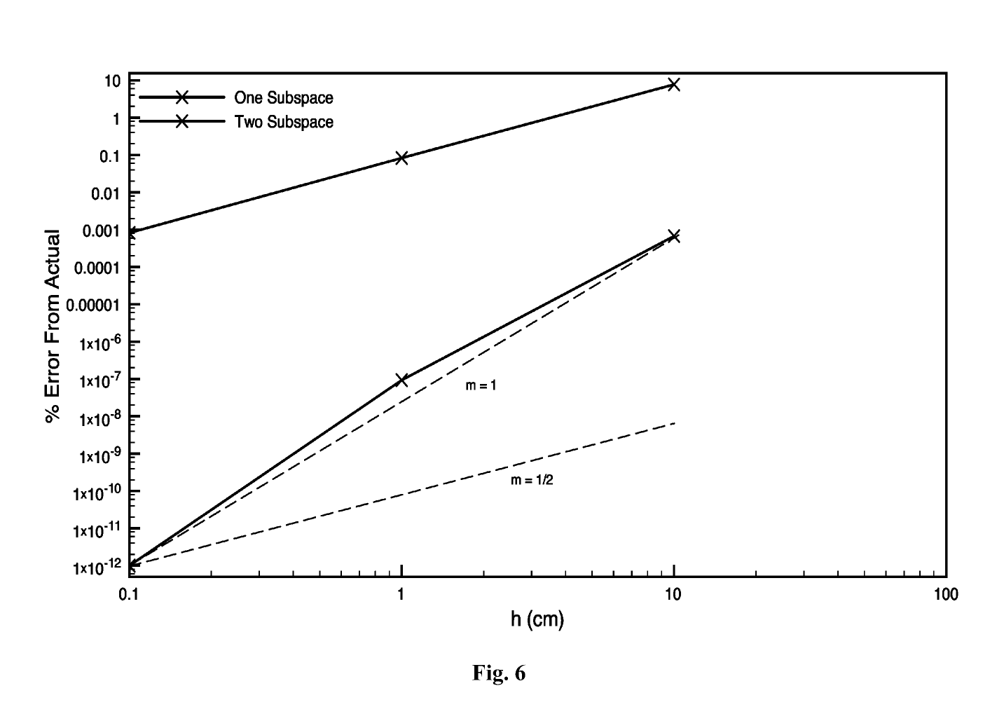

FIG. 6 shows that using two subspaces versus one also gives much faster convergence. Notice how the two point version has a steeper slope than the one point version, following the expected O(h^{2k}) convergence, (where k is the number of points).

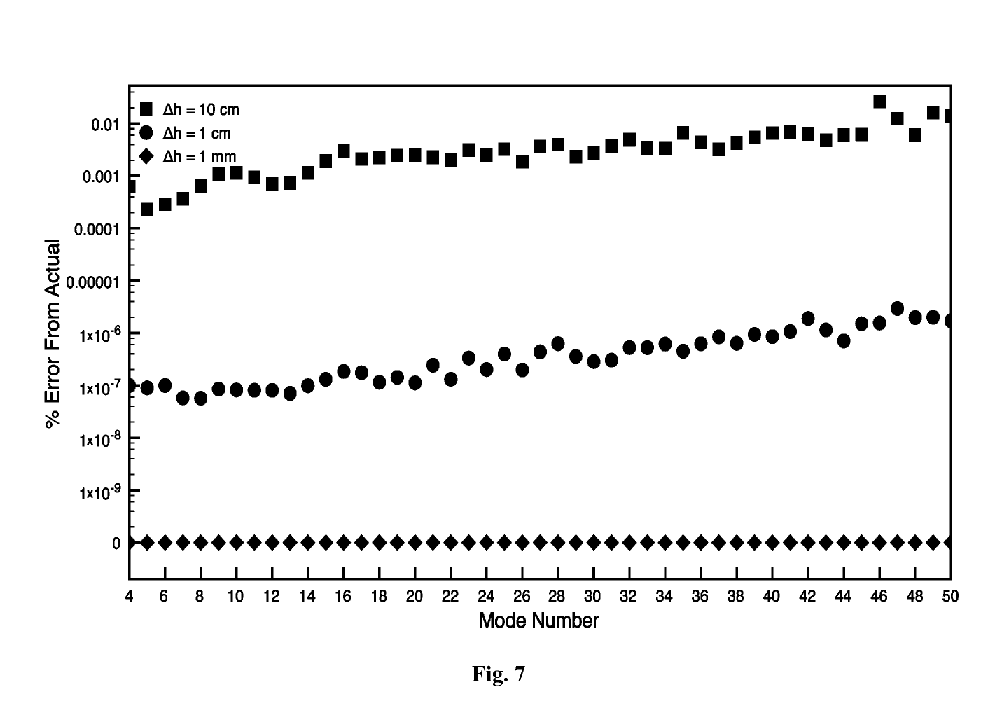

We also investigated using a larger subspace. Instead of using the first 25 eigenvectors, we use the first 50. FIG. 7 shows how using more eigenvectors from each of the two subspaces improves the estimate of the eigenvalues. Error for the largest step size decreased to 3.95×10−3% for the first 25, and 2.65×10−2% for all 100 eigenvalues.

Geometric Mapping

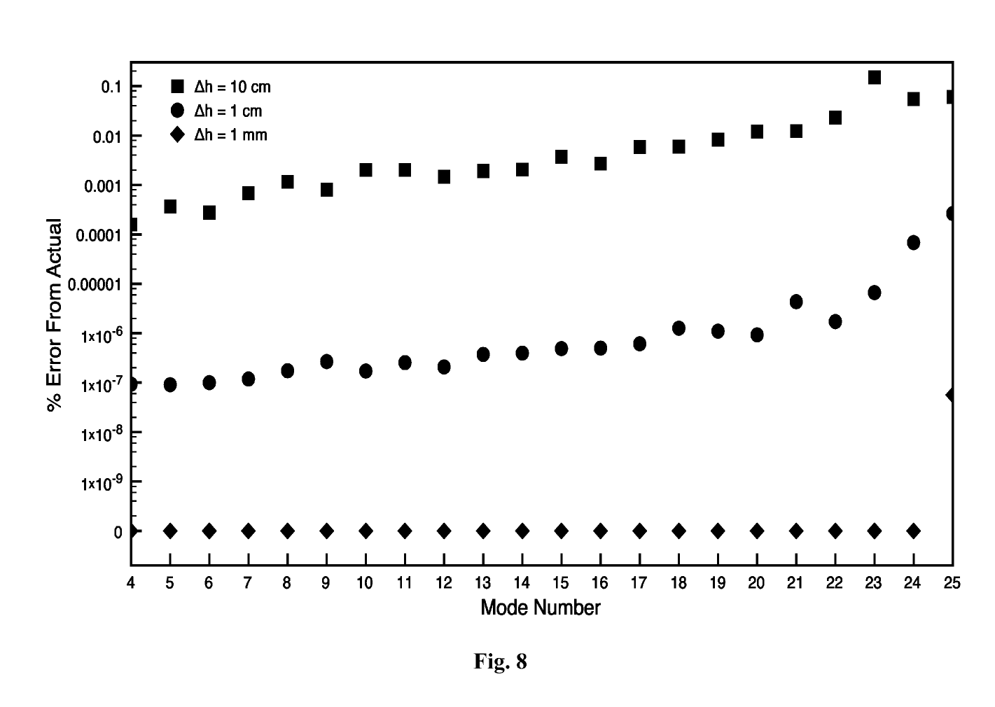

If we remap the eigenvectors from the old geometry to the new geometry using Equation (15), we see the approximations in FIG. 8 when using two subspaces. In this example, the number of nodes in the mesh remained constant as no re-meshing was performed. These results show that using geometric remapping preserves the minimum error of 0% and improves the maximum error to 0.15% for the largest step size.

Remeshing

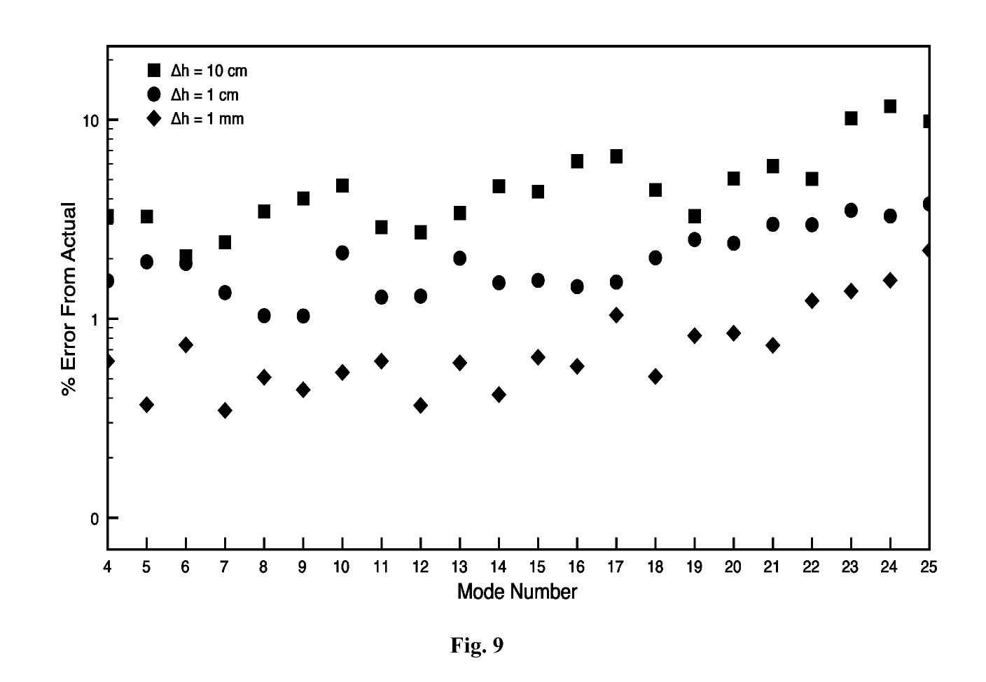

For the cases where the geometry needs re-meshing, we can map the eigenvectors from the old geometry to the new using Equation 12. FIG. 9 shows the error in approximations using two subspaces. These results show that even for changes of up to 20% of the original object size, it is possible to predict the resulting frequency spectrum to within 11% error. This means that instead of performing a time-consuming partial reanalysis, one can make a reasonable estimate to the new spectrum even for large changes in geometry. Notice that remeshing breaks the previous convergence relationships and that the plots do not strictly follow the O(h^{2k}) relation, hence the closer spacing between the approximations.

### EXAMPLE 2

### Shaped Plate

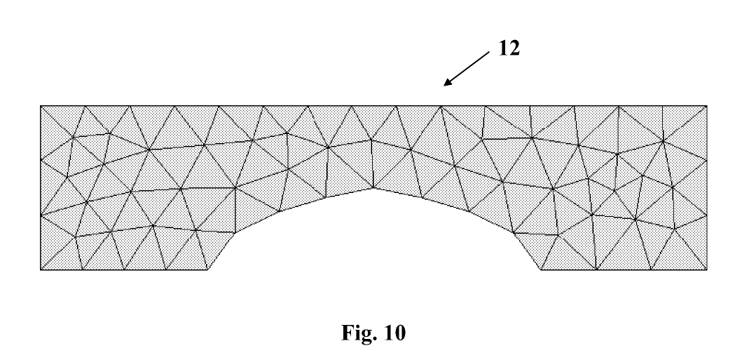

Next we examine the preferred method of estimating the resonant frequencies on a more complicated plate 12 shown in FIG. 10. This plate is 0.8 m×0.2 m with a elliptical hole on one side and is made up of 106 plate elements.

No Geometric Mapping

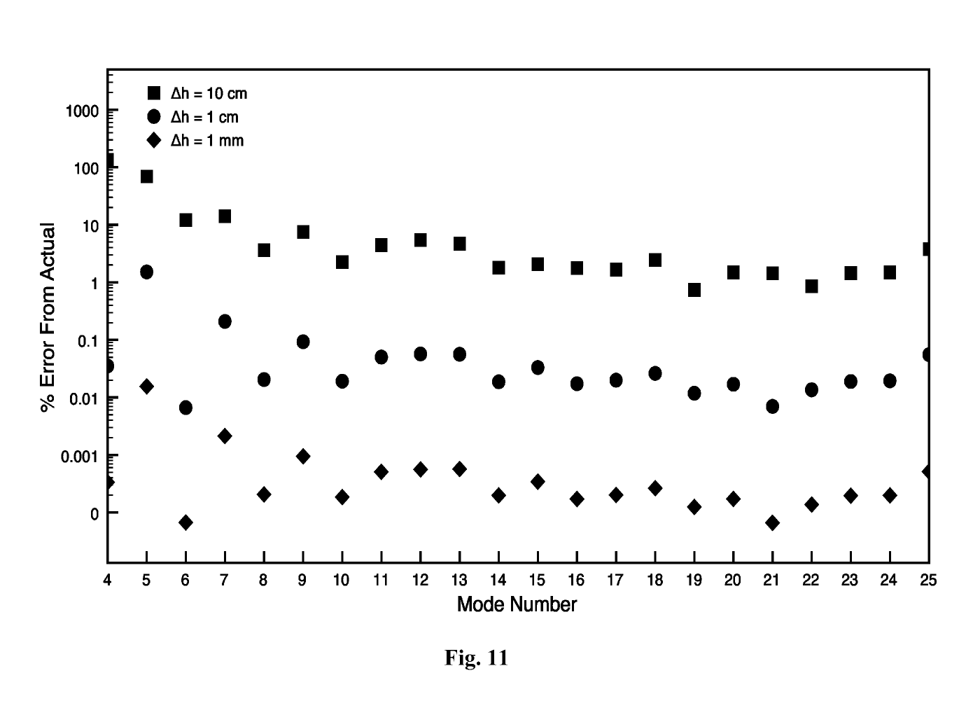

When simply concatenating the previous eigenvectors, the approximation to the actual eigenvalues are shown in FIG. 11 for various changes in square height using one sample point. These results show errors of 0.15% for the smallest and 87.5% for the largest step sizes.

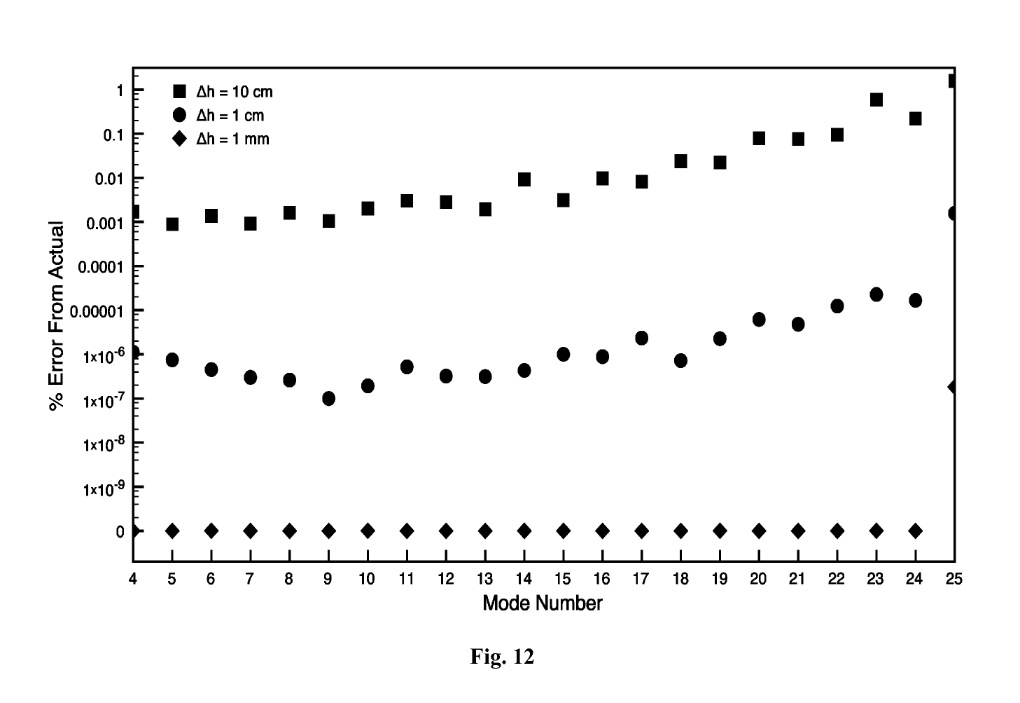

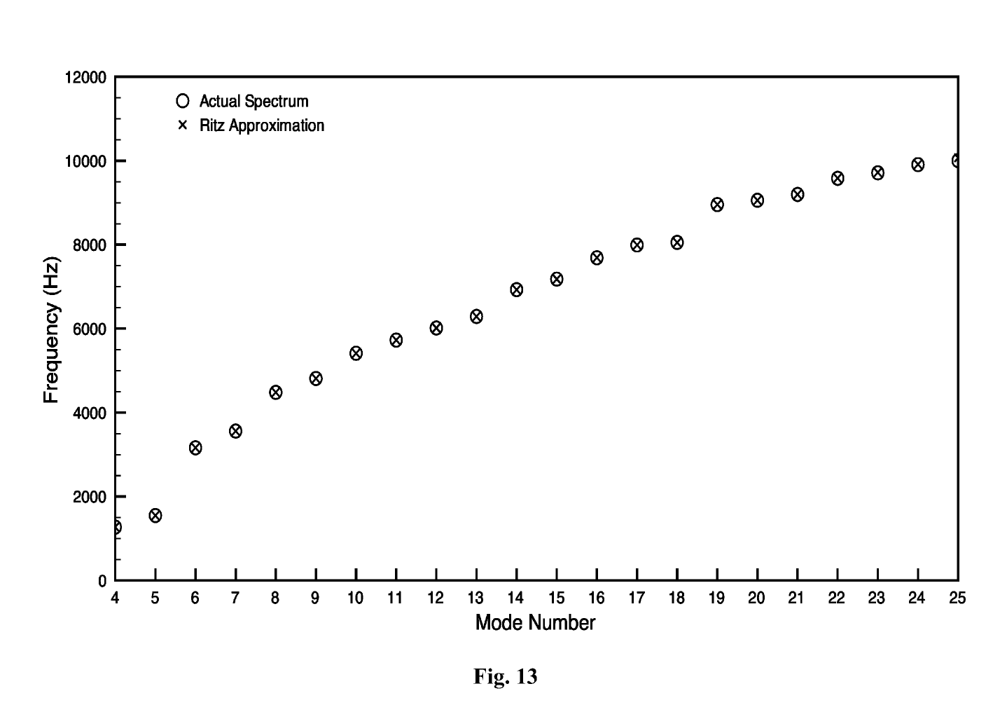

Using two sample points improved the predictive capabilities to 1.24×10⁻7% for the smallest and 1.56% for the largest step size, as shown in FIG. 12. FIG. 13 shows a comparison of the actual and the predicted spectrum.

Geometric Mapping

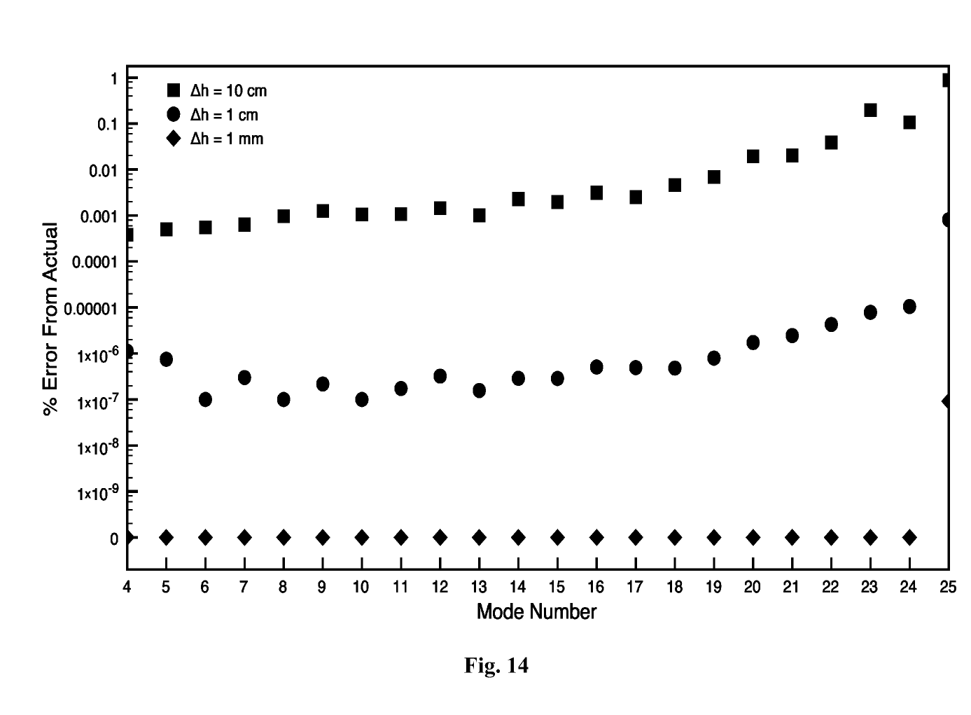

If we remap the eigenvectors from the old geometry to the new, the approximation improves the largest step size error to 0.88%, as shown in FIG. 14.

Remeshing

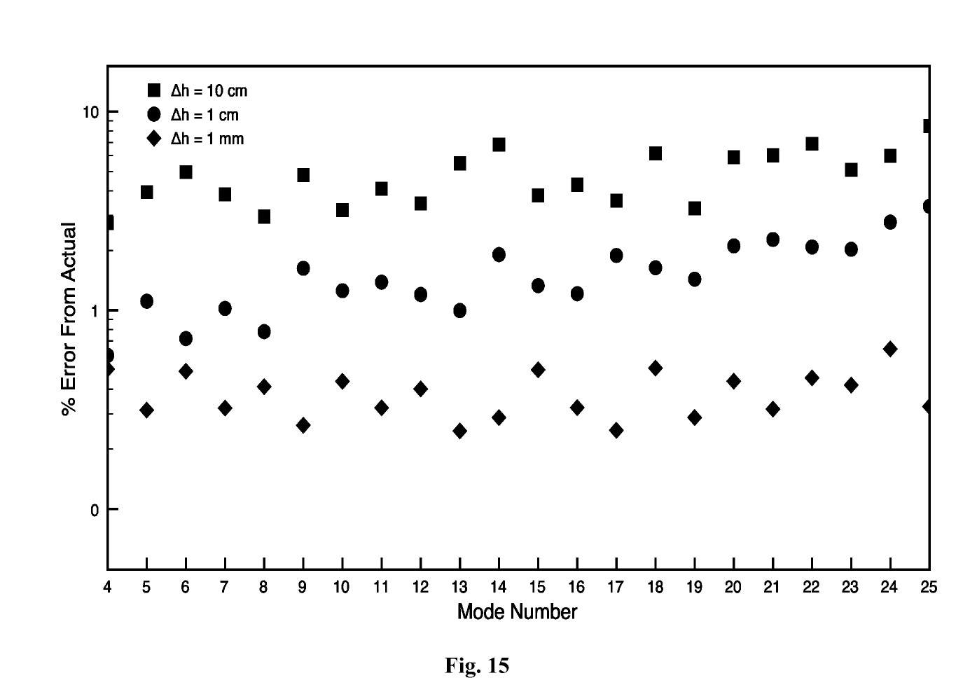

When remeshing the geometry at each sample point, the prediction capabilities follow the curves shown in FIG. 15. These results show a maximum error of 8.47% using geometric remeshing. This means that even for a 25% change in the height of the object, we can still accurately predict the new spectrum.

### EXAMPLE 3

### Marimba Bar

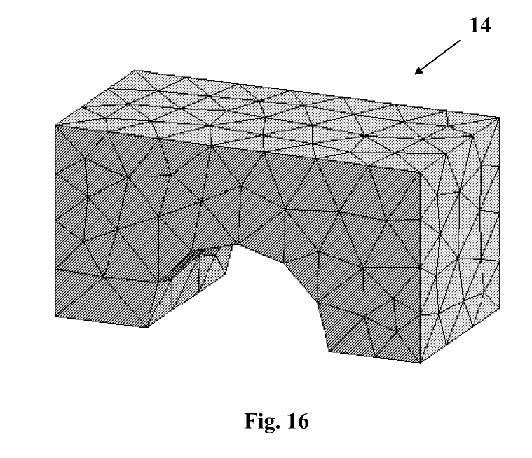

To illustrate the approximation capability for 3D objects, we extrude the previous plate to form a marimba bar 14, which is shown in FIG. 16. This object is 0.2 m×0.1 m×0.1 m and is made of 619 tetrahedral elements.

No Geometric Mapping

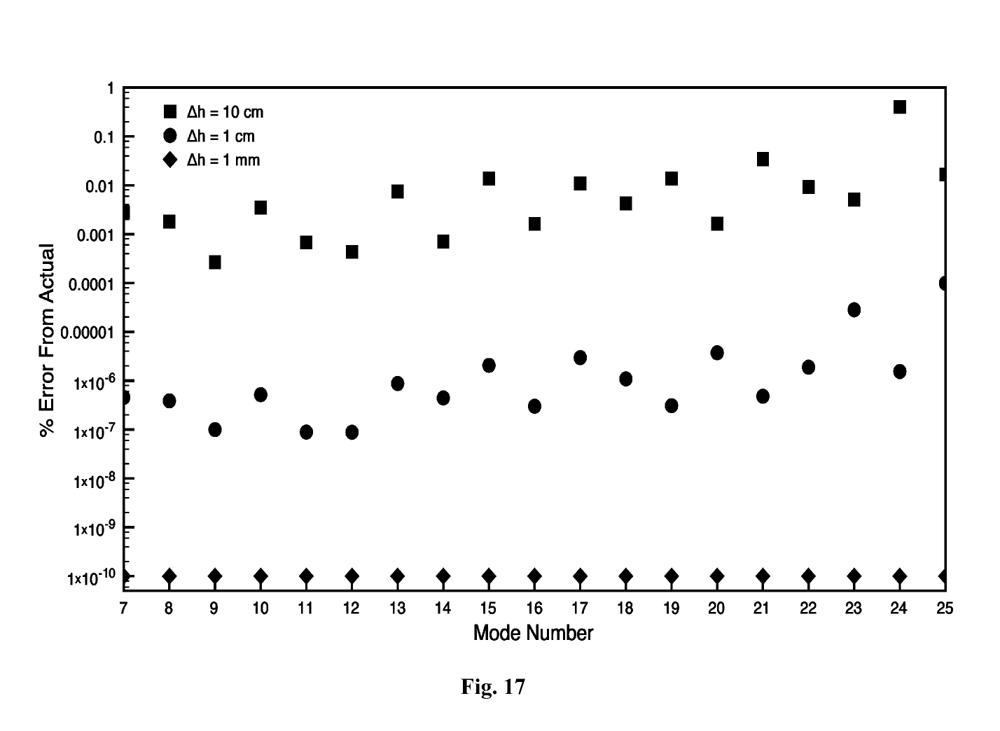

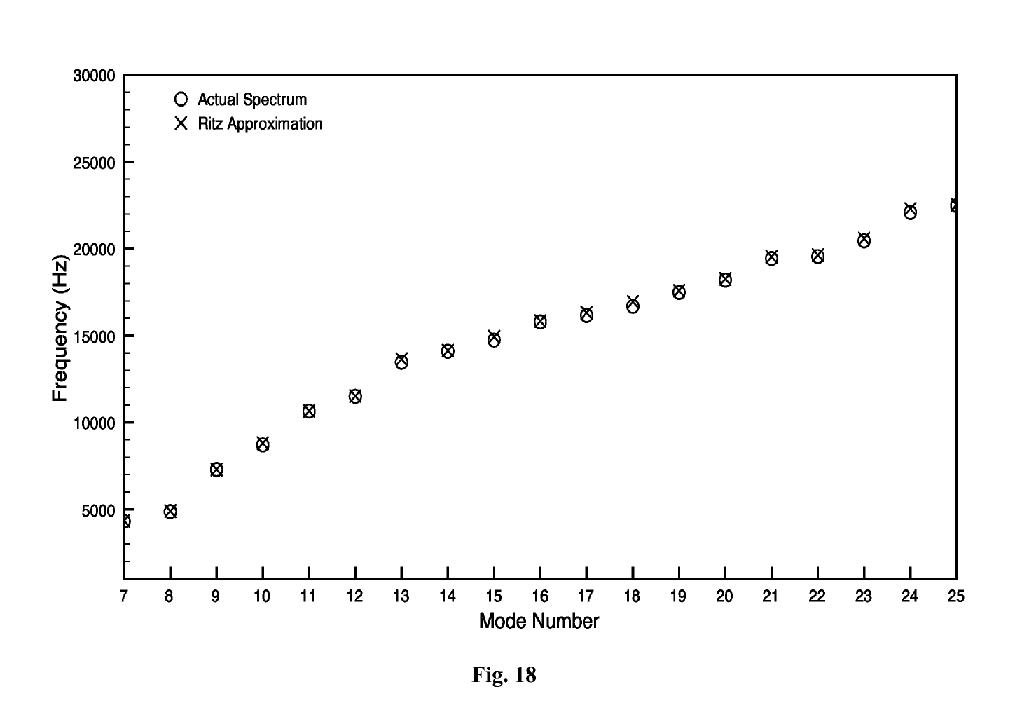

We examine the error when changing the height of the object by 10 cm, 1 cm, and 1 mm using two sample points. FIG. 17 shows the maximum error is 0.40%, and FIG. 18 shows that the spectrum prediction is quite accurate for even a 10 cm change in geometry.

Geometric Mapping

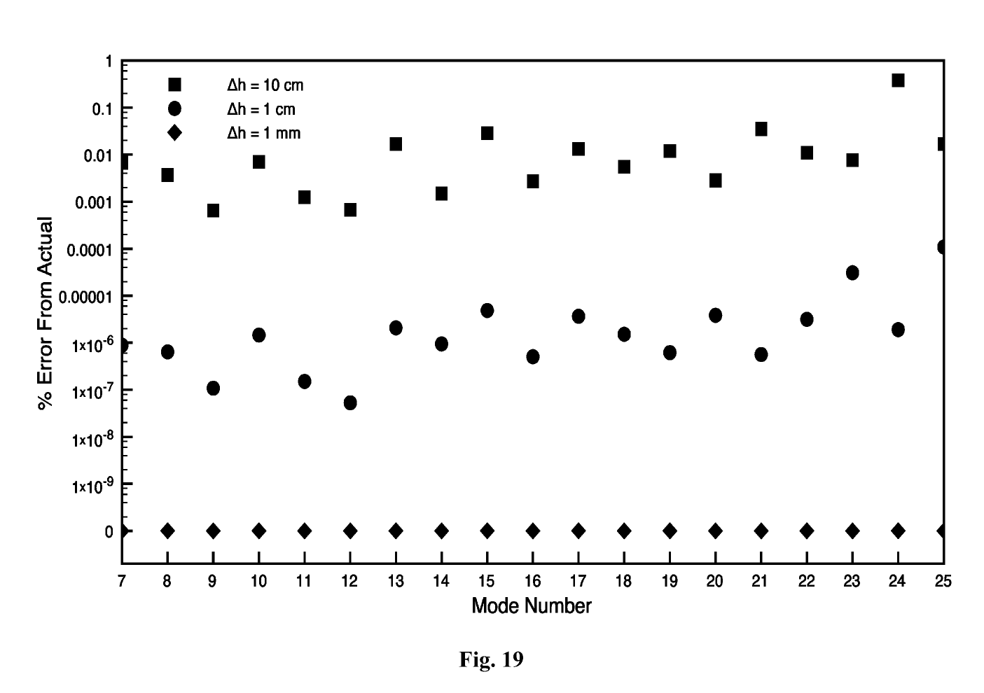

Using geometric mapping and two sample points, the maximum error decreases to 0.38% (see FIG. 19).

Remeshing

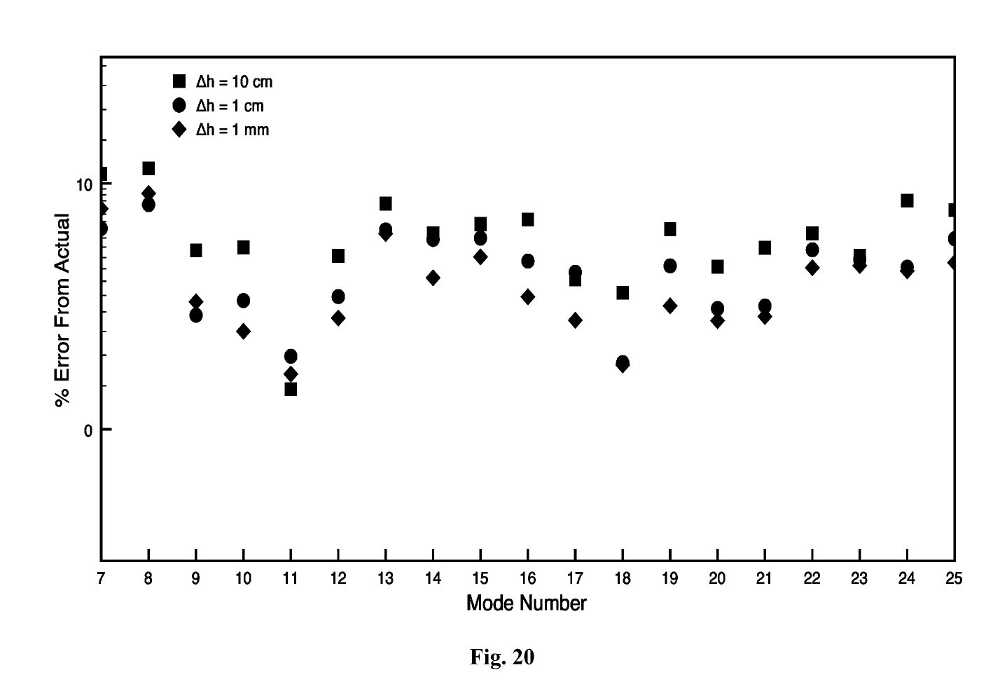

When remeshing the geometry, the maximum error in FIG. 20 is 11.5%. Notice that for this example, the error is not necessarily only proportional to the step size, which shows that other factors, such as mesh similarity between steps, can also increase accuracy.

### EXAMPLE 4

### Axisymmetric Geometry

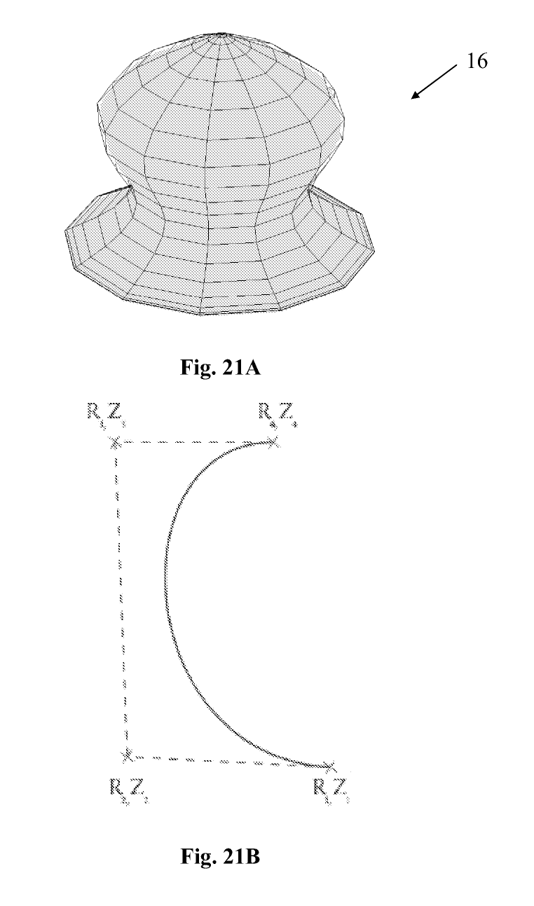

This example uses a parametric geometry, as shown in FIG. 21A. For this geometry, we used a linear shell finite element formulation. Each element consists of four nodes each with six degrees-of-freedom.

We examine a shell whose curvature is defined by four control points as shown in FIG. 21B. The crosses indicate the points modified directly. We use this curve segmented into lateral points which are interpolated using uniform cubic B-spline interpolation.

The control points define a curve which is then revolved around the z-axis to form an axisymmetric geometry. By changing the location of these control points, we change the geometry parametrically. We examine changing a 1 m tall by 1 m radius object shown in FIG. 21A. We change this object's outermost radius by 10 cm, 1 cm, and 1 mm and examine the error in eigendecomposition.

No Geometric Mapping

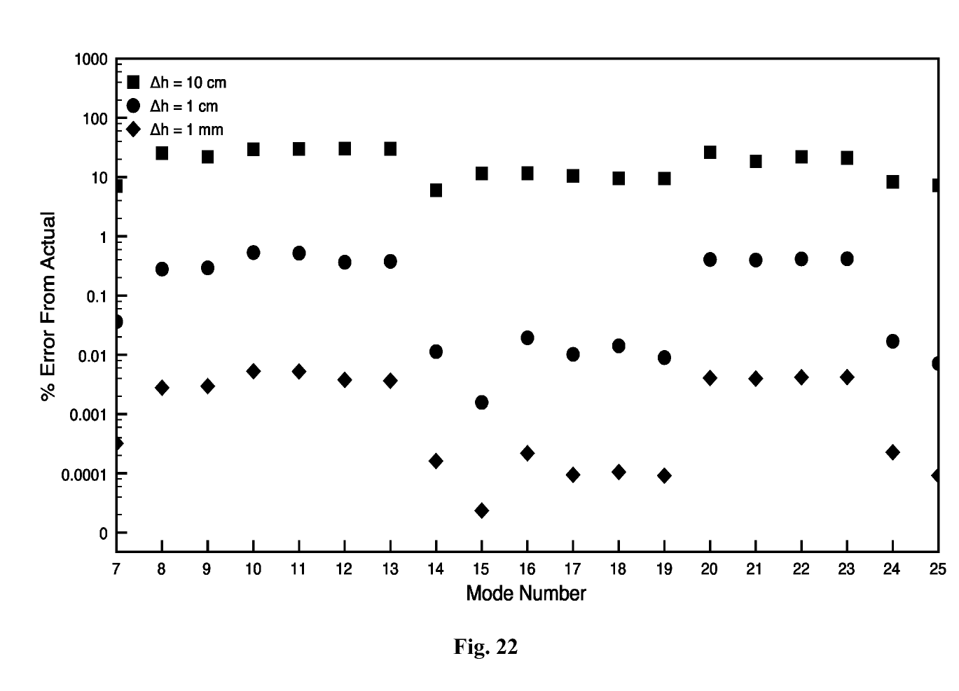

Using only one sample point in parameter space, s, we examine the accuracy in prediction of the Ritz values. The results in FIG. 22 show prediction errors of 0% for the smallest step size and 30.2% for the largest step size. Again, smaller changes in geometry allowed for better prediction of the new eigensolution.

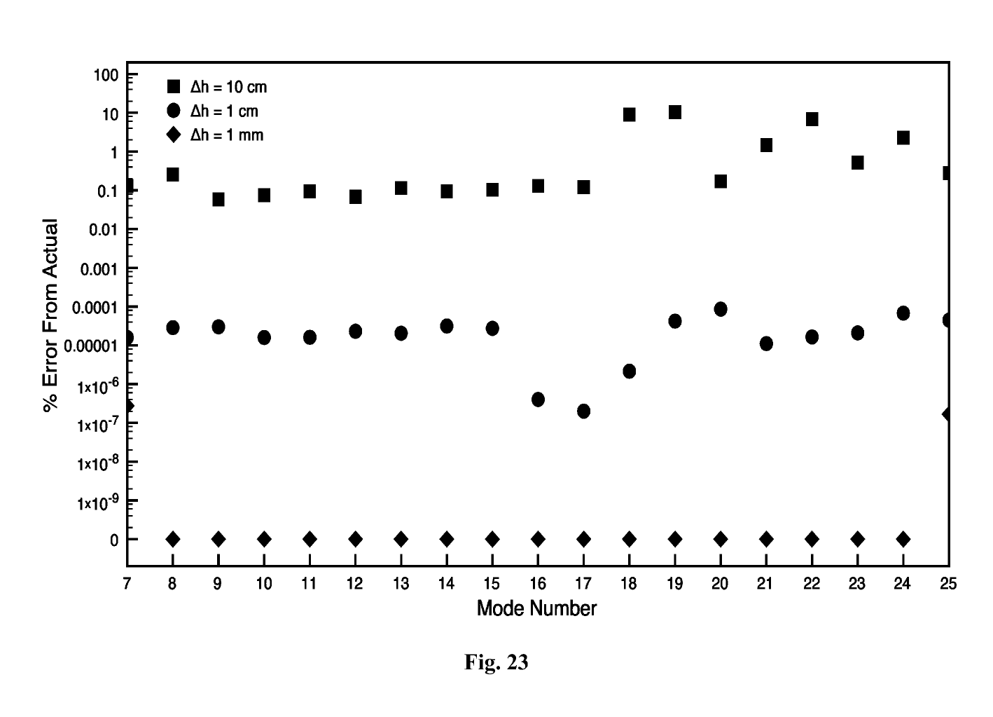

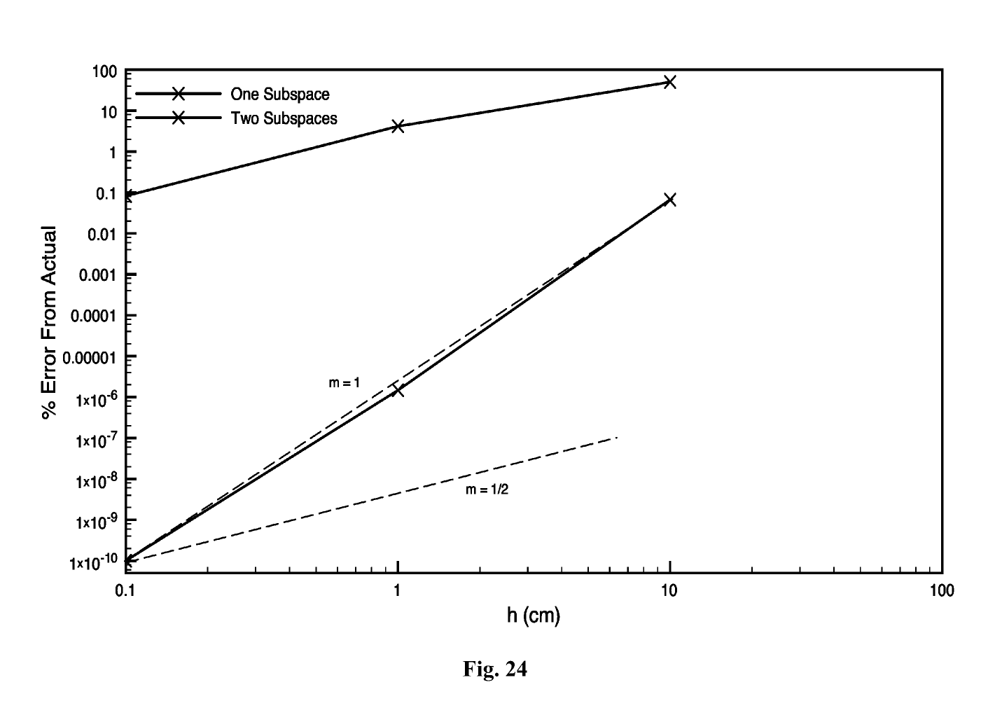

Next, we examine using two sample points. FIG. 23 shows the results for the different step sizes. Again using more points in parameter space increases the accuracy of the predictions by reducing the maximum error to 13.9%. FIG. 24 shows again that using two subspaces versus one also gives much faster convergence.

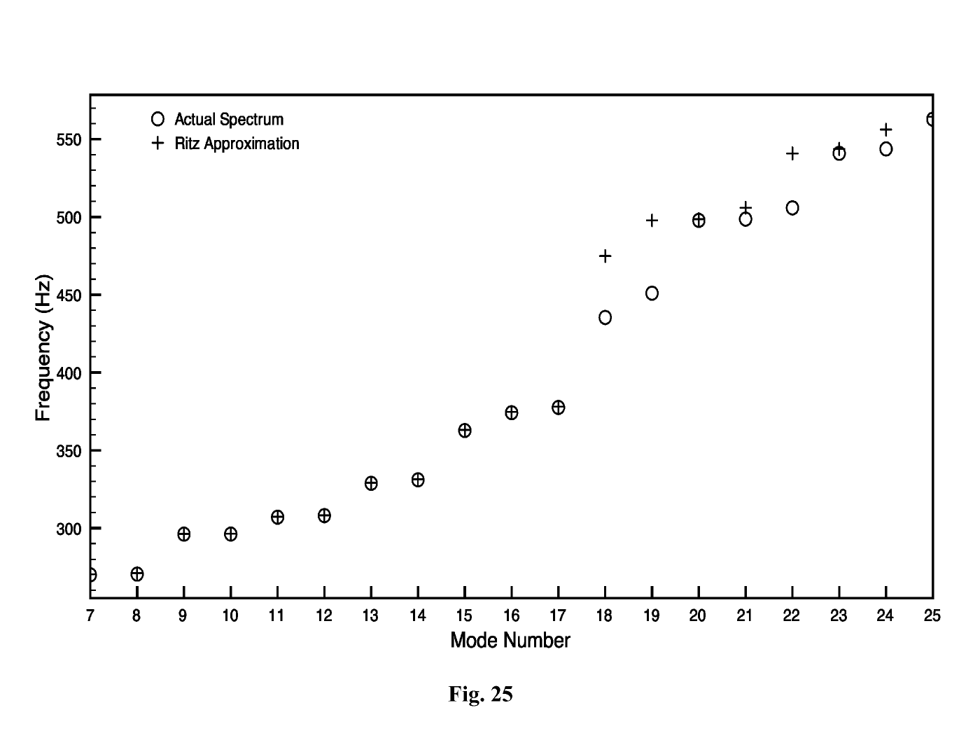

Note that the axisymmetric bell has many more repeated eigenvalues than the previous models. FIG. 25 shows that the spectrum has several repeated eigenvalues.

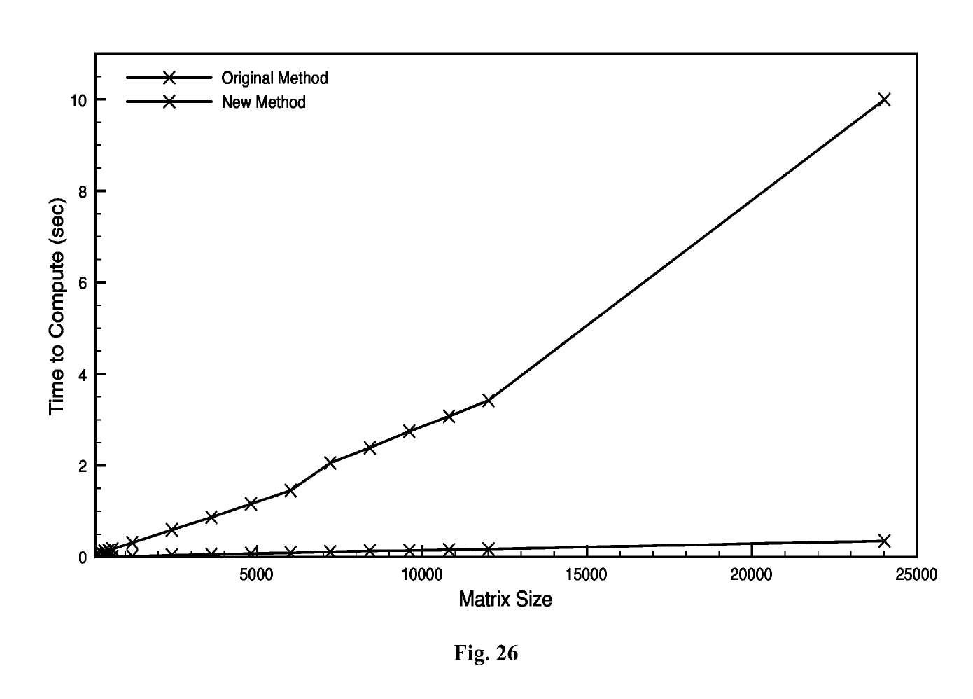

The speedup gained by using this method over traditional reanalysis is the difference between modest linear and super-linear computing time once the initial k samples have been computed. FIG. 26 shows the speedup using this method without remeshing, over using reanalysis for increasing resolution of the object shown in FIGS. 21A-B.

The results from Examples 1-4 above illustrate that the preferred tracking method can be used to predict the changes in the frequency spectrum of an object as parametric changes are made. The results show that without remapping, it is possible to avoid recomputing the eigendecompositions in order to resolve the resonant frequencies of interest for moderate changes only. With geometric remapping, one can make significant changes to the geometry and still accurately retain the frequency spectrum. Even in the worst case when the mesh is significantly different, one can still accurately and rapidly predict the new spectrum.

By exploiting the properties of the system matrices, we can verify the O(h²k) bound on the errors produced using different step sizes. For an interactive design tool, this would mean that the software could alert the user when errors above a given threshold have been made and signal the need for a full reanalysis. This can be used in the tuning stages of design.

For systems with many repeated eigenvalues, such as axisymmetric systems, it may be beneficial to use analysis techniques that will factor out the multiple eigenvalue problem.

### Interactive Software Instrument System

The present invention provides a software instrument that, using the rapid resonant frequency evaluation methodology previously discussed, allows the user of the software to hear the resulting frequency spectrum in real-time as changes are made to an object's shape and various other sound-shaping input parameters.

The software instrument presents a novel use of 3D models for audio synthesis, as it generates sound in real time, thus allowing a user to feel as though they are “playing” the object by applying forces to a physical interface. The sound synthesis routines are preferably incorporated into a digital synthesizing plug-in that takes as input 3D geometric data. By implementing the system as a software synthesizer, one can interact with the object using software hosts that support the plug-in. Using this design allows for integration with music interfaces, such as a piano keyboard. For interactive sound generation, this software can be written as a plug-in to a host audio rendering engine.

The design of this plug-in can be broken down into the synthesis algorithms used, design of the user-interface, and the overall architecture of the performance environment. The synthesis algorithms used have been previously described. Following is a description of the user-interface and the system architecture.

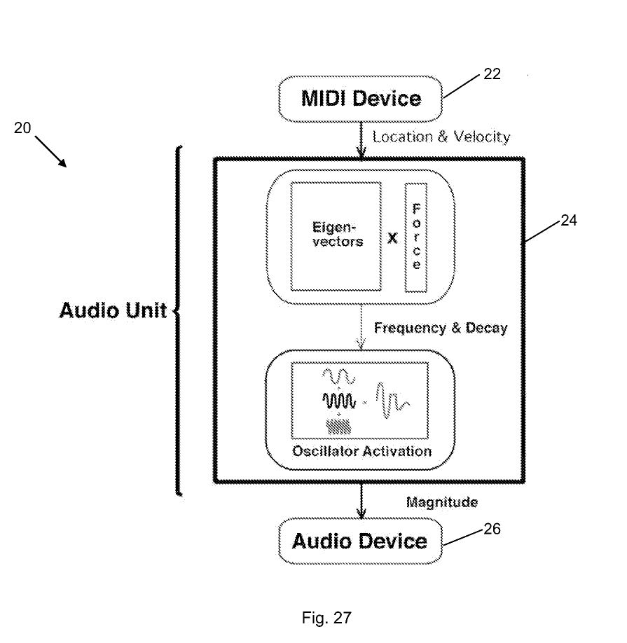

The software is preferably written in C++ and OpenGL APIs for the user-interface. The audio engine for the plug-in preferably utilizes the Core Audio and Altivec APIs. The calls to the synthesizer are made by the host software, which also processes the MIDI/OSC events. In this way, the synthesizer acts as a black box, receiving MIDI/OSC data and producing an audio stream. FIG. 27 is a diagram of the audio system, which shows the principal components of the system 20, namely a MIDI/OSC device 22, plug-in 24 and audio device 26.

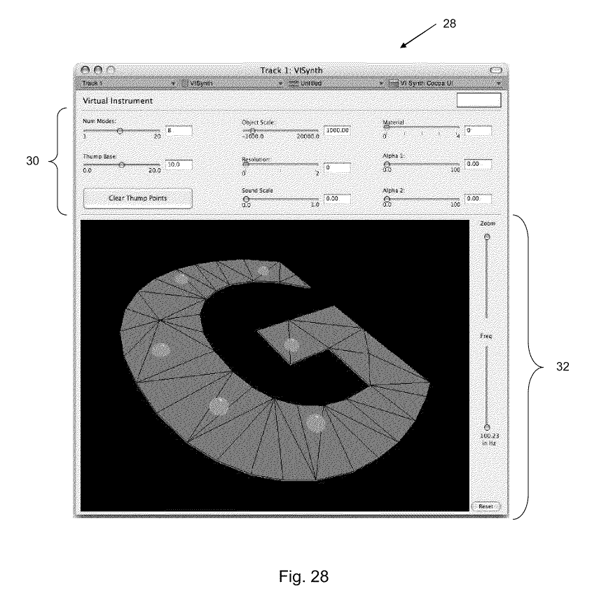

The software instrument provides visual feedback showing the changes to the parameters and the geometry used in the synthesis computations. FIG. 28 shows the user-interface 28 for the virtual instrument plug-in. The top portion 30 of the user interface 28 contains the sliders for parameter adjustment, and the bottom portion 32 gives a 3D view of the model to define the strike position and to examine the mode shapes.

The parameters that the user can control, corresponding to the sliders at the top portion 30 of the user interface 28 in FIG. 28, are size of object, material (from precomputed solutions), damping parameters α₁ and α₂, resolution of the mesh, number of modes used for the computation, radius of the striking object, base impulse applied to the object (that MIDI/OSC key-press velocity then scales), and volume control.

Using the frequency scale to lower or raise the natural frequencies affects the perceived object size and material. Alternatively, one can adjust the material to achieve the desired natural frequencies. One can also examine the results of the modal decomposition by iterating through the mode shapes. A slider selects the mode vibrating at a natural frequency (whose value is displayed at the bottom of the slider) and displays the corresponding shape deformations in the viewing window.

Using the mouse, the user selects a specific locations to strike the object. The radius of the striking object determines the area over which the force is applied. These locations are mapped to keys on a MIDI/OSC keyboard. Once the location and key are mapped, the velocity of the key press determines the intensity of the impulse applied to the model. The strike direction is determined by the angle between the viewing direction and the normal of the surface at the strike location. The plug-in can also be modified to allow for lateral striking directions as well.

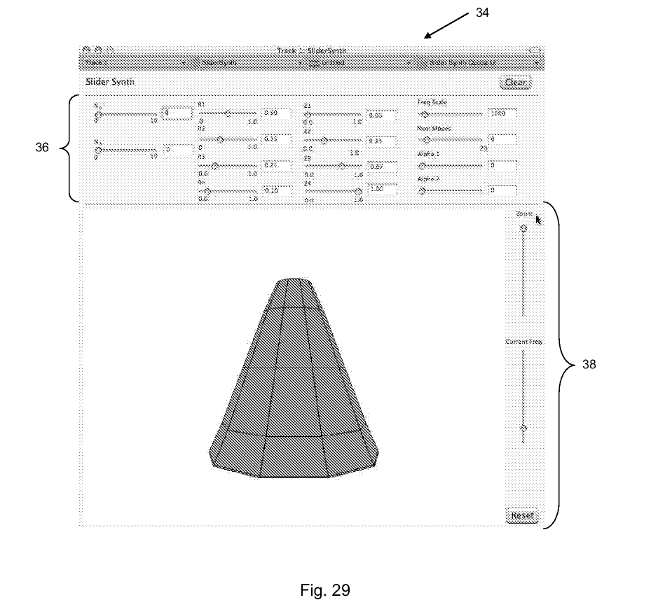

FIG. 29 shows the user interface 34 for the shape changing plug-in. The top portion 36 of the user interface 34 contains the sliders for parameter adjustment, and the bottom portion 38 gives a three-dimensional view of the model to define the strike position and examine the mode shapes. The parameters that the user can control, corresponding to the sliders at the top of the plug-in, are as follows: the material parameters, such as damping (α₁ and α₂); audio rendering parameters, such as number of resonators (Num Modes) used and a frequency scaling (Freq Scale); geometric parameters such as number of radial (N_{R}) and lateral (N_{N}) segments, as well as height (Z), and radii (R) of the control points.

Again, the user interacts with the object by selecting locations on the object's surface with a mouse click. These locations are mapped to keys on a MIDI/OSC keyboard. Once the location and key are mapped, the velocity of the key press determines the intensity of the impulse applied to the model.

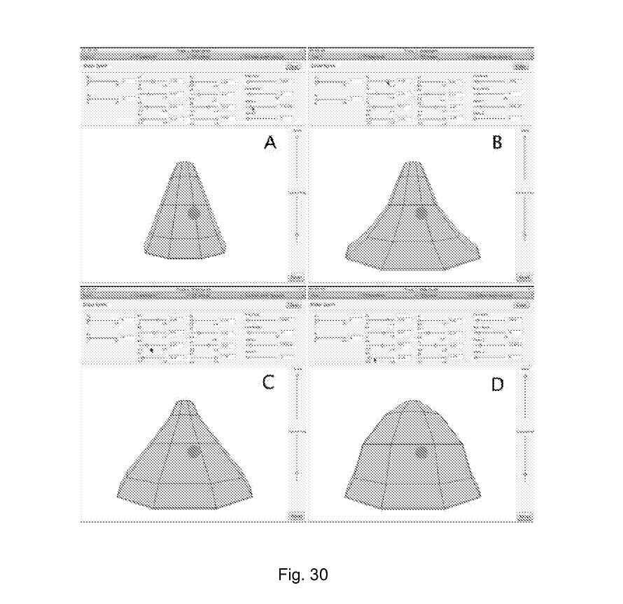

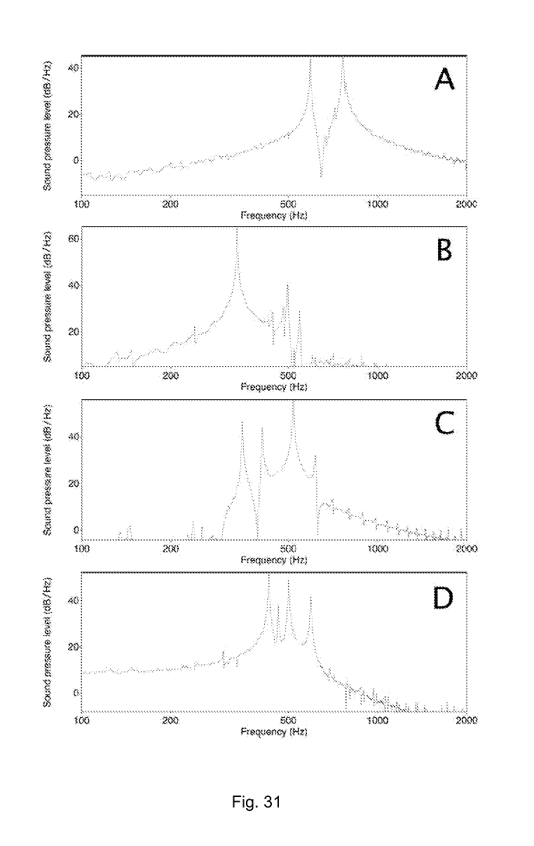

Using the instrument software, the user can generate sounds from objects as geometric modifications are made and then hear the changes in frequency spectrum as a function of shape. FIG. 30 shows four different models made from modifying the control points. FIG. 31 shows that as the radii of the different segments are changed, the peaks in the spectrum move in ways that would otherwise be difficult to predict. While the peaks stay within the 200 to 2000 Hz range, the number and strength of each vary in the each of different shapes, thus illustrating that.

### Interactive Software Effect System

As described previously, the sound synthesis engine can be programmed as a virtual instrument plug-in which receives MIDI/OSC controller data as a signal to start the audio rendering process. To support musical gestures that are more complex than a single strike (or impulse) to the object, the software instrument system can be modified to support controllers that send more complicated force profiles. The following describes methods of generating arbitrary force profiles from controller data and modification to the software instrument system that can be used as an audio effect.

The software system described previously maintained a process that listened for an incoming MIDI/OSC signal which notified the audio processing engine of the value of a given MIDI/OSC controller. Controllers can be keys on a keyboard, position of sliders, angles of a modulation wheel, etc. For this system, the key controllers are mapped to locations on the surface of an object so that when their value is changed, the force applied to the surface changes. Because the MIDI/OSC device used is velocity sensitive, one can simulate striking the object with varying force by pressing the keys with varying velocity. Other controllers can be mapped directly to the synthesis parameters allowing for flexible and smooth modification of the synthesized sound.

The engine listening for MIDI/OSC signals also tracked the current state of the controller, such as attack (where initial contact with the surface is made), sustain (where the exciter remains in contact with the resonator), and release (where the exciter leaves the resonator's surface). These different states can be used to further add detail to the rendering engine, such as adding transients on attack to simulate bouncing or friction. For interactions that have longer contact times, the state can be sustained to indicate that micro-contact is occurring.

There are, however, controllers which use more natural gestures to generate control data. For example, haptic feedback devices can be used to link the sound synthesis engine with user-perceived applied forces. Other controllers such as the drum pads, wind controllers and special-purpose voltage to MIDI/OSC conversion devices can be used to generate these complex force profiles.

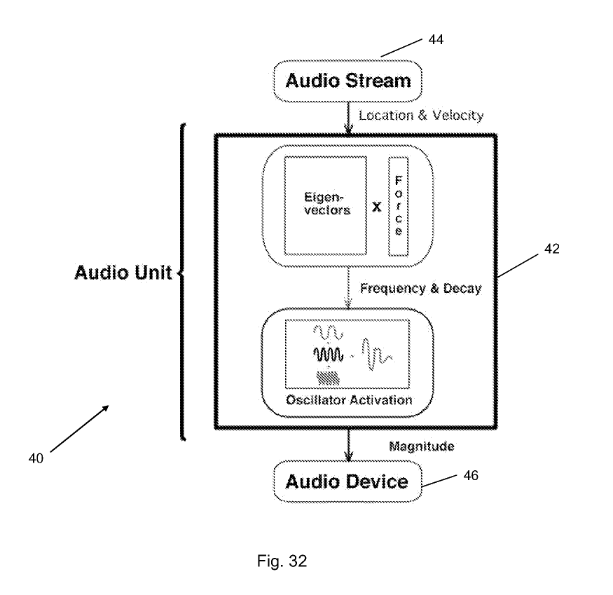

As shown in FIG. 27, the plug-in 24 uses controller data as an input to generate sound in an instrument mode of operation. However, one can also use an arbitrary waveform, instead of simply controller data, as input to the model. This is illustrated in the diagram of the audio system 40 in FIG. 32, where the plug-in 42 receives an audio stream 44 as an input with the audio output sent to an audio device 48. In this way, the bank of resonators can be used to simulate artificial reverberation.

Using the modal synthesis method, we can compute a plate reverberation model in real-time and still allow for modifications of the plate and input/output parameters. To achieve this performance, we use the same finite element model and apply forces using the discrete convolution integral method. This reverberation is an effect plug-in that takes an audio stream as the input and produces the sound of the object vibration as the output.

The rendering algorithm works by first performing the modal decomposition and then filtering the incoming audio through the resonator bank produced. The time to compute the modal decomposition depends on the number of modes required and the number of elements in the finite element model. The software system achieves real-time performance by first computing the decomposition. The system only computes the decomposition at the start of the audio rendering. The previously described methodology for rapidly computing this decomposition is used when the object undergoes a shape change or other changes are made to the model. We then evaluate for each audio sample.

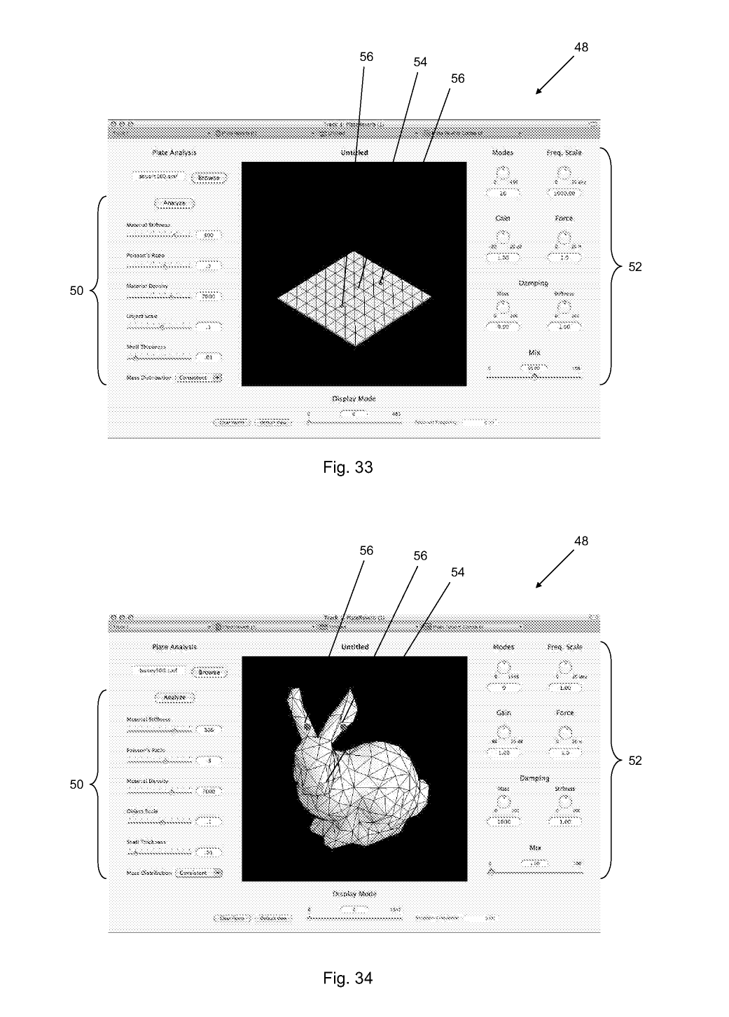

The user interface 48 for the plug-in loads an object geometry and displays the surface for specifying the input and pickup locations (see FIG. 33). The left portion 50 of the user-interface 48 allows for modification of the material parameters, object scale and plate thickness. These parameters are adjusted before modal decomposition. The right portion 52 of the user interface 48 has controls for the audio rendering parameters such as the frequency scaling and resonator decay. These parameters do not require reanalysis, instead they are applied to the bank of resonators as audio is rendered. There is also control for the number of resonators used for simulation. Using more resonators creates a fuller tone but requires more computation.

The following examples were computed using one processor of a dual 2.5 GHz PowerPC G5. In each example, the points 54 represent the input position and the points 56 represent the pickup locations.

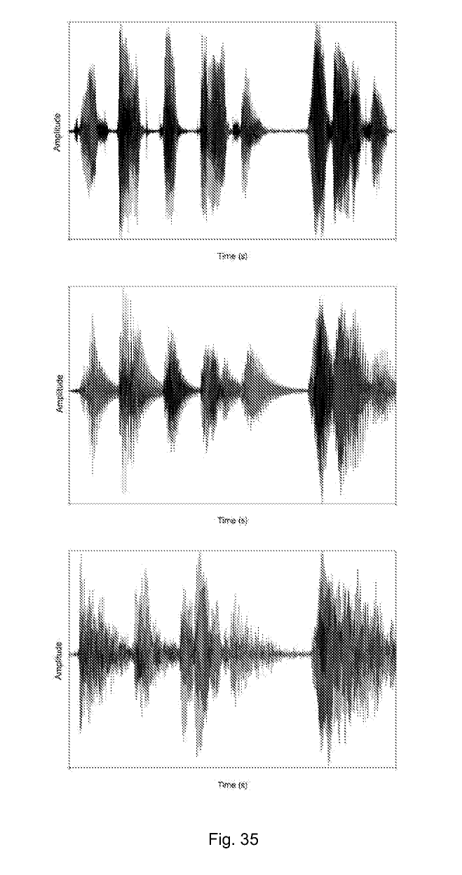

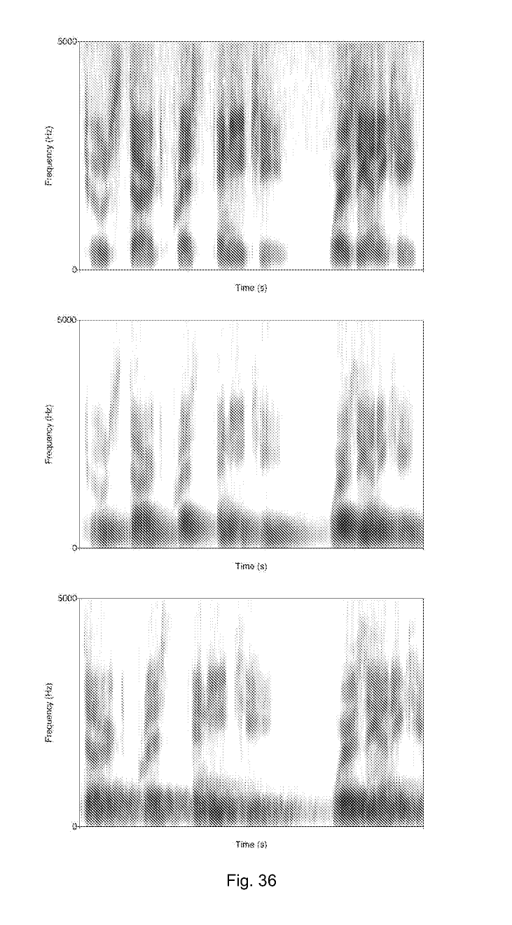

For the first example shown in FIG. 33, a simple plate model is loaded. The model has 100 elements, and the time to compute the decomposition into 485 modes was 0.65 seconds. FIG. 35 (top) shows the waveform and FIG. 36 (top) shows the spectrogram of the incoming signal applied to the plate. FIG. 35 (middle) shows the resulting waveform and FIG. 36 (middle) shows the frequency profile generated for the left channel. One can see the effect of reverberation on the resulting audio. Where there were once discrete peaks, the audio now blends together. Moreover, the frequency spectrum is low-pass filtered through the number of modes used in the synthesis algorithm.

The software system can also be used with novel shapes to explore the effect on the resulting audio. FIG. 34 (bottom) shows a more complex shell surface with arbitrary input and output locations. This model had 500 elements and took 24.5 seconds to compute all 1548 modes. Using the same input profile as FIG. 33 (top), we can compare the resulting waveform and frequency spectra when rendering through this new geometry (FIG. 35 (bottom), FIG. 36 (bottom)). In FIG. 36, the output through the resonator bank has less of the high frequency components than the original signal. This is to be expected as the resonant frequencies of the set of resonators and user-selected damping values will not exactly match the original signal.

For both of these examples, simulating object vibration using 20 modes consumed around 1.4% of the overall CPU capacity; 100 modes consumed roughly 3%; 1000 modes consumed 22%; 3000 modes used 84% for two channels of stereo processing. These results show that for up to 1000 modes, the method performs well.

The present invention has been disclosed, including its various aspects relating to sound synthesis. The present invention contemplates numerous options, variations, and alternatives, and should not be limited to the details of the embodiments set forth herein.

What is claimed is:

1. A computer-implemented method of simulating in real-time the resonant frequencies of an object of arbitrary geometry as changes are made to the geometry of the object, the method comprising:
providing a finite element model of the object to model the geometry of the object;
computing a modal decomposition for the finite element model;
modifying the geometry of the object and the corresponding geometry of the finite element model;
computing estimated resonant frequencies for the object as modified; and
rendering a simulated sound for the object as modified by applying an impulse to the object as modified.

2. The method of claim 1 wherein the step of computing estimated resonant frequencies for the object as modified is performed using the Rayleigh-Ritz method.

3. The method of claim 1 further comprising the step of displaying a three-dimensional graphical representation of the object on a computer display.

4. The method of claim 3 further comprising the step of displaying a three-dimensional graphical representation of the object as modified on the computer display.

5. The method of claim 1 wherein the sound is capable of being rendered from a plurality of locations on the object.

6. The method of claim 5 wherein the sound is rendered from a selected location on the object.

7. The method of claim 5 wherein the plurality of locations are mapped to controllers on a digital interface and the method further comprises the step of receiving an input from the digital interface to apply the impulse to one of the plurality of locations on the object.

8. The method of claim 7 wherein the impulse is an audio stream.

9. The method of claim 8 wherein the digital interface is a MIDI/OSC-type interface and the controllers are keys on a MIDI/OSC keyboard.

10. The method of claim 9 wherein a velocity of a key press on the keyboard determines the intensity of the impulse applied to the object.

11. The method of claim 1 wherein the object is a musical instrument.

12. The method of claim 1 wherein the object is not rotationally symmetrical.

13. The method of claim 1 wherein the finite element model is provided for modeling the geometry and material composition of the object and the method further comprises the steps of specifying a material composition for the object and modifying the material composition of the object in the finite element analysis.

14. The method of claim 13 wherein the object is selected from the group consisting of loudspeaker casings and architectural resonant spaces.

15. The method of claim 1 further comprising the steps of computing an error measurement for the estimated resonant frequencies and generating an alert when the error measurement has a value above a pre-determined threshold.

16. A computer-implemented method of designing an instrument in real-time, comprising:
providing a finite element model for the instrument;
computing a modal decomposition for the finite element model;
displaying a three-dimensional graphical representation of the instrument on a computer display;
modifying the geometry of the instrument and the corresponding geometry of the finite element model;
displaying a three-dimensional graphical representation of the instrument as modified on the computer display;
computing estimated resonant frequencies for the instrument as modified; and
rendering a simulated sound for the instrument as modified by applying an impulse to the instrument as modified.

17. The method of claim 16 wherein the step of computing estimated resonant frequencies for the instrument as modified is performed using the Rayleigh-Ritz method.

18. The method of claim 16 wherein musical notes are mapped to controllers on a digital interface and the method further comprises the step of receiving an input from the digital interface to apply the impulse to the instrument as modified.

19. The method of claim 18 wherein the digital interface is a MIDI/OSC-type interface and the controllers are keys on a MIDI/OSC keyboard.

20. The method of claim 19 wherein a velocity of a key press on the keyboard determines the intensity of the impulse applied to the instrument.

21. The method of claim 16 wherein the instrument is not rotationally symmetrical.

22. The method of claim 16 further comprising the steps of specifying at least one material for the object and modifying the material of the object in the finite element analysis.

23. The method of claim 16 further comprising the steps of computing an error measurement for the estimated resonant frequencies and generating an alert when the error measurement has a value above a pre-determined threshold.

24. The method of claim 16 further comprising the step of further modifying the geometry of the instrument after rendering the simulated sound.

25. A software article for interactive use by a user in simulating plate reverberation in real-time for structures represented by a finite element model of the geometry of the structure, the software article comprising:
a computer readable medium having instructions for performing the steps of computing a modal decomposition for the finite element model, rendering a three-dimensional graphical representation of the structure on a computer display, receiving an input from the user to modify the geometry of the structure, modifying the finite element model for the structure based upon the input from the user, rendering a three-dimensional graphical representation of the structure as modified, computing estimated resonant frequencies for the structure as modified, and rendering a simulated sound by applying an impulse at one of a plurality of locations on the structure as modified.

26. The software article of claim 25 wherein the estimated resonant frequencies are computed using the Rayleigh-Ritz method.

27. The software article of claim 25 wherein the input from the user to modify the geometry of the instrument relates to a shape of the instrument.

28. The software article of claim 25 wherein the input from the user to modify the geometry of the instrument relates to a size of the instrument.

29. The software article of claim 25 wherein the finite element model represents the shape and composition of the instrument and the computer readable medium including instructions for receiving an input from the user to modify the material composition of the instrument and modifying the finite element model for the material composition as modified.

30. The software article of claim 25 wherein the computer readable medium including instructions for receiving an input from the user to modify an audio rendering parameter.

31. The software article of claim 25 wherein the audio rendering parameter is a number of resonators used.

32. The software article of claim 25 wherein the audio rendering parameter is frequency scaling.

33. The software article of claim 25 wherein the structure is non-rotationally symmetrical.

34. The software article of claim 25 wherein the impulse is defined by an audio stream.

35. The software article of claim 33 wherein the structure is selected from the set consisting of loudspeaker casings and architectural resonant spaces.

36. A software article for interactive use by a user in generating sounds in real-time from a virtual instrument represented by a finite element model of the geometry of the instrument, the software article comprising:
a computer readable medium having instructions for performing the steps of computing a modal decomposition of the finite element model, rendering a three-dimensional graphical representation of the instrument on a computer display, receiving an input from the user to modify the geometry of the instrument, modifying the finite element model for the instrument based upon the input from the user, rendering a three-dimensional graphical representation of the instrument as modified, computing estimated resonant frequencies for the instrument as modified, and rendering a simulated sound for the instrument as modified by applying an impulse to the instrument as modified.

37. The software article of claim 36 wherein the step of computing estimated resonant frequencies for the instrument as modified is performed using the Rayleigh-Ritz method.

38. The software article of claim 36 wherein the instrument is non-rotationally symmetrical.

39. The software article of claim 36 wherein musical notes are mapped to controllers on a digital interface and the method computer readable medium further includes instructions receiving an input from the digital interface to apply the impulse to the instrument as modified.

40. The method of claim 39 wherein the digital interface is a MIDI/OSC-type interface and the controllers are keys on a MIDI/OSC keyboard.

41. The method of claim 40 wherein a velocity of a key press on the keyboard determines the intensity of the impulse applied to the instrument.

42. The software article of claim 29 wherein the input from the user to modify the geometry of the instrument relates to a shape of the instrument.

43. The software article of claim 36 wherein the computer readable medium further includes instructions for receiving an input from the user to modify an audio rendering parameter.
